(19) United States
(12) Patent Application Publication
(10) Pub. No.: US 2012/0021783 A1
(43) Pub. Date: Jan. 26, 2012

(54) TELECOMMUNICATIONS SERVICES APPARATUS AND METHODS

(76) Inventor: Jeffrey Wilson, Southampton (GB)

(21) Appl. No.: 13/144,018

(22) PCT Filed: Jan. 9, 2009
(86) PCT No.: PCT/GB2009/000055

§ 371 Date: Jul. 11, 2011

(51) Int. Cl. H04W 4/12; G06F 17/27

(52) U.S. Cl. 455/466; 704/9; 704/E11.001

(57) ABSTRACT

A telecommunications service or application has associated with it a set of exceptions which, in effect, define a set of matchable inputs from a user and corresponding answer functions to be performed in the event of the particular input. An input user text message (50) is tested against a list (51) of exceptions sequentially until a match is found, and then the corresponding answer function is executed. The matching process, inter alia, divides the input text into one or more parts, and information derived from or associated with one part of the input text is used together with information derived from or associated with another part of the input text (or a part of a previous input text) to control the response of the system to the input text (such as the response to be provided to the (user). For example, attributes associated with different identified parts of the input text are cross-referenced to see if the different parts of the input text have any attributes in common.

The present invention relates to methods and apparatus for interpreting and responding to text messages, such as, for example, text messages transmitted in a mobile communications system. It has particular, but not exclusive, application in the fields of information storage and retrieval by text, and in the provision of text-based interfaces, that allow users to interact with automated systems, for example, and particularly, in the field of mobile telecommunications.

Communication using text messages, such as SMS messages in a GSM mobile communications system, is nowadays very common and often a preferred form of communication. Its is becoming increasingly desirable therefore to provide services and applications that users can interact with via text messages. However, a difficulty with this is providing the ability to interpret and respond appropriately to a user's text messages. Ideally, it would be possible for a user simply to use natural language in their text messages, but it is difficult for an automated system to be configured to be able to interpret and respond to the range of possible natural language messages that a user could submit.

The Applicants have previously proposed in EP 1185119 an automated information system in which factual data in text form is stored hierarchically and can be queried using text messages via a hierarchical menu structure.

However, in this arrangement, the data must be organised manually into a suitable hierarchy, and the menu options must be created manually to allow the stored data to be navigated. This approach is very labour intensive and while it may be suitable for smaller, closed applications with a very limited data set, it is not suitable for more general text-based systems, where, e.g., the size of the data set may be very large or may grow over time.

AIML (Artificial Intelligence Markup Language) is an XML dialect aimed at natural language processing. However, the primary method of context memory used by AIML allows a matching rule to refer to a previous machine-output by using a tag. In order to use this method, a separate rule is required for every combination of new input and previous machine output, leading to a combinatorial explosion of complexity in the rule set. This means that this method is not realistically scalable, since every new output added could potentially require a large number of new context rules to be added.

Prolog is another computer language that has been applied to language processing. Prolog is rule based, and lends itself to logical processing of grammars based on a set of construction rules. However, language tends to be irregular and Prolog is unsuited to dealing with such irregularity.

Indeed, the Lighthill Report (Professor Sir James Lighthill, “Artificial Intelligence: A General Survey”, UK Science Research Council) stated that AI researchers had failed to address the issue of “combinatorial explosion” when solving problems within real-world domains. In other words, while traditional AI techniques could work within the limited scope of small problem domains, the techniques would not scale up when applied to more realistic problems, such as natural language processing. This applies to both AIML and Prolog.

The Applicants believe therefore that there remains scope for improvements in the field of text message processing, in particular in relation to the provision of automated service and applications that can be controlled and interacted with via text messages.

According to a first aspect of the present invention, there is provided a method of processing an input text message in an automated text message processing system, the method comprising:

the system:

using a matching process to divide an input text message into one or more parts; and

using information derived from or associated with a part or parts of the input text determined by the matching process, together with information derived from or associated with another part or parts of the input text determined by the matching process and/or with information derived from or associated with a part or parts of a previous input text, to control the response of system to the input text message.

According to a second aspect of the present invention, there is provided an apparatus for interpreting and responding to a text input message received by the apparatus, the apparatus comprising:

means for processing an input text message using a matching process to divide the input text message into one or more parts; and

means for using information derived from or associated with a part or parts of the input text determined by the matching process, together with information derived from or associated with another part or parts of the input text determined by the matching process and/or with information derived from or associated with a part or parts of a previous input text, to control the response of system to the input text message.

In the present invention, an input text message is processed and divided into one or more parts by using a matching process. (This may involve, e.g., and preferably, attempting to match a part or parts of the input text to a predefined text string or set of text strings, etc.)

Then, information derived from or associated with a determined part or parts of the input text is used, together with information derived from or associated with another determined part or parts of the input text (and/or of a previous text input), to control the response of the system to the input text message. This facilitates, as will be discussed further below, a better text processing system and that can, in particular, provide better resolution of potentially ambiguous terms (e.g. because they may have multiple possible (predefined) meanings) in the input text.

For example, the word “Mercury” could be predefined in the text message processing system as potentially having the meaning the god Mercury, the planet Mercury or the element Mercury. Identifying the word “mercury” in an input text message (e.g. by matching to the word “mercury”) may not therefore on its own allow the system to resolve the intended meaning of that term in the input.

However, in the case of an input “What is the diameter of Mercury?”, if the system can identify the term “diameter” in the input (e.g. by matching it to “diameter”), it may by, e.g., cross-referencing the identified term “diameter” with information associated with “Mercury”, recognise that “diameter” only makes sense if “Mercury” is referring to the planet Mercury. Thus, the potentially ambiguous word “Mercury” in the input can be resolved as meaning the “planet Mercury” using information derived from or associated with the determined parts “diameter” and “mercury” in the input text. The system can then provide a response that is appropriate for the meaning “the planet Mercury”.

Thus the present invention provides in particular an improved technique for resolving ambiguity in text inputs where a matching process is used. Indeed, in a particularly preferred embodiment, the information derived from or associated with the determined parts of the input text (or a previous input text) can be and preferably is used to (attempt to) resolve ambiguity in the interpretation of the input text message.

Furthermore, as will be discussed further below, the present invention can be particularly flexible in its use, and can provide a powerful means for quick and effective text interaction with automated systems.

The input text message that is subjected to the matching process may, e.g., simply comprise all or part of the text message in the form that it is sent by the user.

However, in a preferred embodiment, the text message as sent by the user is processed to a derived form to form an input text message that serves as the input text message for the process of the present invention (that serves as the input text message to the matching process). This preferably comprises rendering the input text message with a predefined character set, entirely in lower case, removing any redundant white space, and/or removing any accents in the user's input text message.

Thus in a preferred embodiment, the present invention comprises steps of or means for receiving a text message and processing that text message to a derived form to form an input text message that is then provided to the matching process, etc.

Preferably, an input text message as sent by a user may be processed to one or more derived forms that are then input to the matching process, etc. Thus, in a particularly preferred embodiment, an input text message is processed to two or more derived forms that are then each input to the matching process. In this case, the user's single input text message will be processed to a plurality of derived input text strings that are submitted to the matching process.

The matching process may then attempt to match one or more of the derived forms of the input text message and thereby, in effect, select or choose its response based on an appropriate one of the derived alternate forms of the input text message (being, e.g., the derived form that is found to form an appropriate match).

For example, while in some cases it may be more straightforward to identify a match to an input if all punctuation in the original message is removed, for an input that includes a decimal number or a fraction, it may not be desirable to remove all punctuation from the user's input before submitting it to the matching process, as the meaning of the number may then be lost.

Thus, for example, the user's text message is preferably processed to a form that retains all the punctuation of the user's message, to a form that retains some but not all of the punctuation of the user's message, and to a form that removes all of the punctuation of the user's message.

This will then allow the system both to provide a form of the input in which all punctuation has been removed, and a form of the input that retains, e.g., any decimal points used in the input to the matching process, with the matching process then identifying the most appropriate form (by virtue of matching it) for the user message in question.

It should be noted here that where more than one derived form of the input message is generated, it is not necessary for the matching process to process each and every derived form of the input message identically. For example, where the matching process uses stored “exceptions” (as will be discussed further below), one or more of the exceptions may be defined as requiring the input text message to be in one particular derived form or forms and the system may attempt to match only the input text in that particular derived form (or forms) to that particular exception or exceptions.

Thus, for example, some exceptions may only have one particular derived form or forms of the input text message submitted to them as part of the matching process, whereas other exceptions may have different, or all of the, derived forms of the input text message submitted to them. Preferably, each exception can indicate the form(s) of input text message it requires and the system will operate accordingly. Similarly, a given derived form of the input text message may be attempted to be matched to all or to only some of the exceptions as part of the matching process.

Preferably a predetermined standard character set (or sets) is used for all inputs to the matching process, and input text messages as sent by a user, etc., are converted or mapped to one or more standard, predefined character sets before being submitted to the matching process. For example, character mapping tables could be used to map accented characters to a standard character set or sets.

Other arrangements, would, of course, be possible.

The input text to the matching process (which may be a derived form of the user's original message, as discussed above) is subjected, as discussed above, to a matching process to divide that input text into one or more parts (and preferably into plural parts). This could comprise, e.g., dividing the input text after each word in the text, or a given part or parts that the input text is divided into could comprise plural words from the input text if desired.

Any suitable text matching process can be used for this purpose.

The input text to the matching process is preferably split into several parts for the matching process (and as a result of the matching process), with each part being matched in turn. The input text may be split into single words or into groups of plural words, or both, for this purpose. This may depend, e.g., upon the nature of the input, the nature of the matching process, etc.

The matching process preferably divides the input text into parts by attempting to match the input text to one or more predefined text strings (defined for the matching process), and then dividing the input text into parts on the basis of the predefined text string(s) that the input text has been found to match. In a particularly preferred embodiment, this done by the matching process attempting to match the input text to one or more of a plurality of predefined (and stored) exceptions to be matched against input text messages, each exception defining at least one text string that a text string derived from an input text message must match for the exception to be matched (and references herein to an “exception” or “exceptions” should be interpreted, unless the context otherwise requires, accordingly). The input text is preferably then divided into parts on the basis of the exception that is matched.

The exceptions in these arrangements of the present invention effectively represent, as will be appreciated by those skilled in the art, possible inputs from a user so that it can then be determined whether a current user input corresponds (matches) or not. They can thus be thought of as string representations against which input messages are tested, but unlike in systems such as Prolog, the exceptions do not try to represent the construction rules of language, but rather each define a particular input (or set of inputs, as will be discussed further below) against which the input text message should be matched.

The effect of this is that the matching process will process and interpret the input text messages by relating them to the exceptions or irregularities of the input text (language), rather than trying to use the regular rules of language to do so.

The text string(s) that will be considered to match to an input text message (to an exception) may be defined in any suitable way. In a preferred embodiment this is done by using syntax denoting the text string or strings. For example, the literal text string that is to be matched May be defined.

The text strings defined for matching purposes are preferably defined (and stored) in a standardised form (e.g. using a predetermined, standard character set), e.g., and preferably, that corresponds to the derived form (or to at least one of the derived forms) to be used for the input text messages.

In a particularly preferred embodiment, a given exception can be defined as matching to a plurality of different input text strings, for example by the exception being defined as matching to two (or more) different strings of text that are defined as alternatives and for which a match with any one of the defined alternatives will match the exception.

In a preferred embodiment an exception may include a “wildcard” that is to be considered to match any text (that is in the appropriate place) in the input text (i.e. the “wildcard” in the exception will be considered to be matched whatever the relevant input text is (and thereby allow the remainder of the input text string to be matched to the remainder of the exception (if it does so)).

Similarly, in a preferred embodiment, a part or parts of a text string defined as matching to an exception can be defined as being optional, i.e. such that it or they do not need to be present in an input text message for the exception to be matched.

Thus, in a particularly preferred embodiment, an exception for the matching process can be defined as matching to a single string of text only, as matching to a plurality of different strings of text, or as matching to any input text string (i.e. to an infinite number of different strings of text).

Where used, the exceptions are preferably searched sequentially looking for a match to the input text message. Most preferably, an input text message is tested against some or all of a set or sets of stored exceptions one after another until a match is found.

In a particularly preferred embodiment, the exceptions are tested (searched through) in a particular, preferably predetermined, order. Most preferably the testing order of the exceptions is such that in general more specific exceptions (i.e. exceptions that have more specific matching requirements or constraints) are tested for a match before less specific (less constrained) exceptions.

In a particularly preferred embodiment a text string defined for the matching process can include a defined class (group) of strings of text, such that if the appropriate characters in an input message match any member of the indicated class, the predefined text string will be considered to be matched. This is preferably done by including in the definition of the text string an indicator (a class identifier) that identifies the desired class (group) of text strings.

Thus, in a preferred embodiment a plurality of classes, each class having one or more members, are defined and can be referenced in text strings and exceptions to be matched. Similarly, in a preferred embodiment one or more classes of strings of text can be defined, each class comprising one or more members, and each member of a class defining a text string or strings that is to be considered to match to the class, and a part or parts of a text string derived from an input text message may be required match to one or more of the defined classes of text strings for an exception to be matched.

This allows classes that contain one or more members with each member defining or indicating a string of text that is considered to be a match to the class to be defined and stored, but referenced (used) for the matching process (e.g. in an exception) simply by indicating the relevant class for the text string (e.g., and preferably, by including the relevant class identifier in an exception), rather than having to list each class member in the exception individually. A class thus, in effect, defines a set of things to match against for a (part of) an exception.

The use of “classes” in the predefined text strings and exceptions in this manner accordingly provides a level of indirection in the text matching process that can for example facilitate more flexible definitions of text strings to be matched. It can also allow a given single or few predefined exceptions to match a large number of potential input messages (text strings).

It also means that the number of possible allowed inputs to the system can be increased by adding new members to an existing class and/or by adding a new class. This greatly increases the flexibility and power of the system.

Preferably the system supports and uses a plurality of classes. Similarly, an exception and a predefined text string to be matched can preferably include a plurality of classes, if desired.

Each class may include as many entries as desired. The members of (entries in) a class are preferably related to each other, e.g. in terms of their subject-matter, but this is not essential. A class can preferably comprise a set of different strings of text.

In a particularly preferred embodiment, a class can itself include another class or classes as a member. This is preferably achieved by including the appropriate class identifier(s) as a member (or members) of the class. Such “super” classes (i.e. classes that include classes among their members) can be used to provide a further level of indirection. Preferably a “super” class can contain both “class identifier” members and “normal” class members.

Such a “super” class preferably includes one or more other classes. A predefined text string or exception that includes the class identifier for this “super” class will then match to any member of the one (or more) classes that the indicated “super” class is defined as including.

In a particularly preferred embodiment, entries in classes can and do have associated with them some additional information that can also be used in relation to the class entry, for example for the purposes of text string matching. Most preferably, a class entry can have multiple different forms of information associated with it.

In a particularly preferred embodiment, the additional information associated with a class entry can be and preferably comprises a class identifier. This, in particular in combination with the use of a plurality of additional information for a given class entry, may be particularly useful where, for example, a given word or term may have two or more different meanings and, e.g., accordingly belong to two or more different classes. For example, the word “manx” could be a member of the class “cats” and of the class “language”.

In this case one could also define a further class which has such words as its members, and for which the additional information associated with those class members is the different classes that the class member is a member of. Thus “manx” for example, may in this class be associated with the information “cat|language” (where “|” indicates alternatives). Testing against the additional information associated with “manx” in this class could then, e.g., allow a text string (e.g. exception) to be matched appropriately whether “manx” is being used to mean a language or a cat.

Thus, in a particularly preferred embodiment, the system includes at least one class (and preferably plural such classes) that has as its members words that are members of other classes, and that has associated with each member of this class the class identifiers of each other class that the class member is a member of.

In a particularly preferred embodiment, the system includes a plurality of classes that can be used together to represent possible sentence forms, preferably by including the classes appropriately in an exception to be used for the matching process. For example, there preferably is one or more classes whose members are possible forms of a given verb, whose members are possible subjects, locations, times of day, etc., and/or whose members are possible adjectives or adverbs, etc. By matching to an exception requiring these classes in the appropriate order, an input text message can, for example, be matched, irrespective of the form of the particular verb used in the input text message.

As discussed above, a key feature of the present invention is that information derived from or associated with a determined part or parts of the input text message is used together with information derived from or associated with another part or parts of the input text (and/or a previous input text message or messages) to control the response of the system to the input text message.

As discussed above, this process can be and is preferably used to attempt to resolve or reduce ambiguity in the interpretation of the user's input (e.g. where the input text could potentially have a plurality of different meanings) (and to then control the system's response to the user's input accordingly).

The information that is derived from or associated with a determined part of an input text message (or of a previous input text message) that is used in the present invention can comprise any suitable and desired such information, and, equally, can be derived or determined in any suitable and desired manner.

In a preferred embodiment, this information is determined by matching the relevant part of the input text to a predefined text string as part of the matching process, i.e. by identifying a text string or term that the determined part of the input text matches to. An example of this would be matching (and thereby identifying) the term “diameter” or “mercury” in an input text message, as discussed above.

The information that is then used in the process of the present invention once a matching text string has been identified may, e.g., simply comprise the information that the part of the text message matches that particular text string. This may in particular be done where, e.g., the particular matched text string only has one meaning for it defined in the system. For example, as discussed above, identifying “diameter” in the input text may allow the system to unambiguously interpret that part of the input text as meaning “diameter”.

In a particularly preferred embodiment, the information that is derived from or associated with a part or parts of an input text message that is used in the system and process of the present invention comprises information that is predefined as being associated with a text string (or strings) that the determined part or parts of the input text is determined as matching to by the matching process. Thus, for example, as discussed above, the term “mercury” could be predefined as being associated with the possible meanings “god”, “planet” and “element”.

Thus, in a particularly preferred embodiment, the matching process will use one or more predefined text strings to determine and identify parts of the input text, and one or more of the predefined text strings that the matching process will use to identify parts of the input text have associated with them the information that is then to be used in the process of the present invention.

The association of text strings to be used for the matching process with information for this purpose can be achieved as desired. In a preferred embodiment, this is done using the system of “classes” and “super classes” discussed above, e.g., by having the desired information as additional information associated with the relevant class entry or entries, as discussed above, and/or by defining classes of information for given objects, etc., and then associating appropriate predefined text strings with the relevant classes or superclasses.

For example, “mercury” could be defined as being a member of the classes “planet”, “god” and “element” by including those class identifiers as information associated with “mercury” in an, e.g., “names of thing” class. There could then also be classes having as their members “attributes of planet”, “attributes of god”, and “attributes of element”. Identifying “mercury” in the input could then be used to derive that “mercury” is a member of the “planet”, “god” and “element” classes and the attributes associated with those defined possible meanings of mercury then determined using the relevant “attributes of . . . ” classes.

The response of the system to the input text message may be any desired and suitable operation, and may depend, e.g., on the nature of the application that the text message is being used to interact with. The response could, e.g., be to return a text message to the user, to trigger a database look-up or some other query, to launch an application, etc.

In one preferred embodiment, the response of the system to the input text message comprises providing a response, preferably in the form of a text message, to the user. The response of the system may also, or instead, comprise, and preferably does comprise, updating and/or changing the (internal) state of the system in response to the input text message. For example, the system may update stored data, such as variables, in response to the input. This updated information may then be used, e.g., when processing future inputs.

The system's response may be controlled on the basis of the information associated with or derived from the different parts of the input text in any desired and suitable manner, for example, and preferably, depending on whether that information has allowed the system to make an unambiguous interpretation of the input text message or not, etc. For example, if the process is able to, in effect, resolve all ambiguity in the interpretation of the input text message for the purposes of providing a response to the user and/or setting the internal state of the system, then an appropriate response could be sent to the user, a database look-up triggered, the internal state of the system updated, etc. On the other hand if some ambiguity in the possible meaning of the input text remains, a response seeking further information or clarification could be sent to the user.

It would be possible to, e.g., define one or more text messages that are to be returned to a user that can then be selected between depending on the outcome of the processing of the information derived from or associated with the different parts of the input text.

Thus, in one preferred embodiment, a plurality of possible responses to send to a user are defined, and the information associated with or derived from the different parts of the input text is used to determine which response to send to the user, preferably by selecting which of the plurality of different responses is to be sent to the user on the basis of the information associated with or derived from the different parts of the input text.

In a particularly preferred embodiment, a response “function” is defined that uses the information derived from or associated with the different parts of the input text (and/or the result(s) of processing that information) to then construct a response to the user. For example, the information derived from or associated with the different parts of the input text could be, and is preferably, used to derive information to be used for a database look-up, with the results of that look-up then being returned to the user. For example, as discussed above, a database look-up for the diameter of the planet Mercury could be triggered.

In these arrangements, the response to the user is controlled by using the information derived from or associated with the parts of the input text (and/or a previous input) as, or to derive, an appropriate input or inputs to a function or operation that will then construct or derive a response to be sent to the user.

In a particularly preferred embodiment, there are both one or more predefined text responses, and one or more response “functions”, and the information associated with or derived from the different parts of the text message is used to determine which form of response to provide (and the response that is provided).

Similarly, one or more possible system internal state changes, and/or functions for determining such changes, could be defined, and then, e.g., selected between and/or triggered depending on the outcome of the processing of the information derived from or associated with the different parts of the input text.

Other arrangements would, of course, be possible.

The information that is derived from or associated with the parts of the input text is preferably used in the present invention to apply a constraint or constraints when determining the response of the system (e.g. when selecting the response to be provided to the user, or executing a function or operation to construct or generate that response)) (e.g. when “interpreting” the input text for the purposes of determining a response thereto), preferably to constrain the response to a response that is appropriate for the constraint(s) that has been determined. Most preferably the information is used to apply a constraint or constraints when “interpreting” the other part or parts of the input text for the purpose of determining the system's response.

For example, as discussed above, identification of the term “diameter” in the input text can be used to derive a constraint “planet” to be applied when trying to interpret the term “mercury” for the purpose of determining the system's response.

This is preferably done by, in effect, trying to constrain the interpretation of a part or parts of the input text for the purpose of controlling the system's response to only be able to have a meaning or meanings that is or are appropriate to the information derived from the other determined part of the input text (or of the previous input text). For example, for the input text “How heavy is mercury”, “heavy” could have the attributes “density” or “mass” associated with it, and then the “interpretation” process for “mercury” for the purpose of determining (controlling) the system's response to the user's input could be constrained to only use interpretations of “mercury” that similarly have “density” or “mass” as associated attributes (which may then, e.g., indicate that the planet mercury or the element mercury are allowable interpretations, but the god Mercury is not).

Thus, in one preferred embodiment, there are plural possible responses defined, with each such response being defined as being appropriate to (and/or triggered by) particular constraints to be applied in relation to the input text, and the information derived from or associated with the parts of the input text is used to derive one or more constraints that are then used to determine (e.g. to select) a or the response as to be used accordingly.

Similarly, in a preferred embodiment, there are one or more functions defined for generating or constructing a response for sending to the user, and/or for setting the system's internal state, and the information derived from or associated with the parts of the input text is used to derive one or more constraints that are then used as inputs to, or to derive inputs to, the function or functions.

Thus, in a particularly preferred embodiment, the information that is associated with the one or more predefined text strings that the matching process will use to identify parts of the input comprises one or more attributes that may then be used to derive a constraint or constraints for the purpose of determining the system's response (e.g., and preferably, the response to be provided to the user).

Similarly, the system and process of the present invention preferably uses an attribute or attributes associated with an identified part or parts of an input text message or messages to control the response of the system to an input text message, most preferably by constraining the response of the system to a response (or responses) that is defined as being appropriate for (as making sense for) the attribute or attributes in question.

Most preferably, the system and process of the present invention looks to interpret one or each appropriate part of the input text for the purpose of controlling the response of the system to the input text message (and controls the response of the system) on the basis of what, if any, associated attributes the parts of the text messages have in common.

Thus, in a particularly preferred embodiment, the step of or means for using information derived from or associated with the part or parts of the input text (or a previous text input) comprises a step of or means for cross-referencing information (e.g. attributes) derived from or associated with one part of the input text, with information derived from or associated with another part of the input text (and/or a part of a previous text input), most preferably to see if there is common or matching information (e.g. attributes) associated with the relevant parts of the text input(s). Preferably, the extent to which common or matching or corresponding information (e.g. attributes) is (or is not) found, is then used to determine the response to the user's input.

In effect, this arrangement can be looked on as “intersecting” information derived from different parts of the input text (and/or a previous text input), in order to refine or improve the system's response.

In a particularly preferred embodiment, the matching process has defined for it answer functions that are to be executed in dependence on the results of the matching process. Most preferably each exception to be used for the matching process has associated with it an answer function that is to be executed if the exception is matched (and the system executes an answer function that is associated with a matched exception in response to the matching process).

Any suitable and desired answer functions can be defined and performed. For example, and preferably, an answer function may, as discussed above, trigger a query to an (internal or external) database, launch another program, etc.

In a preferred embodiment, an answer function may define a plurality of functions and/or operations that are to be performed in the event of a match. Preferably some or all of an answer function may be conditional, i.e. is to be performed only if particular conditions are (or are not) met.

Most preferably, an answer function can define one or more possible different text responses to be sent to a user, and/or one or more response generating (constructing) functions, with the actual response to be sent to the user then being determined in dependence on the results of the processing of the information associated with the different parts of the text message(s), as discussed above.

In a particularly preferred embodiment, one or more of the answer functions comprise the outputting of a text string by the apparatus, preferably to the user that provided the original input text message. In a particularly preferred such arrangement, an answer function can include characters or a text string taken from an input text message in a text string to be output as (all or part of) the answer function.

Operation in the manner of the present invention (such as “intersecting” the information, as discussed above) could be attempted in respect of each and every text input that the system receives. However, the Applicants have recognised that this may not be necessary for all inputs, and so in a preferred embodiment, the system of the present invention only operates in this way for selected forms of input. Similarly, there may be exceptions, for example, for which, if matched, operation in the manner of the present invention is not triggered.

Most preferably, an exception to be matched against can trigger operation in the manner of the present invention (if the exception is matched) (and if an exception that is matched does not trigger such operation, then operation in the manner of the present invention is not performed). This is preferably done by indicating in the answer function that is to be executed if the exception is matched that operation in the manner of the present invention should be carried out.

Thus, in a particularly preferred embodiment, an answer function associated with an exception to be matched can indicate (and trigger) operation in the manner of the present invention. In effect, therefore, the matching process will indicate initially a match to the exception, but the answer function will then trigger the process that is to use information (e.g. attributes) derived from the different parts of the input text to control the system's response (preferably, to attempt, as discussed above, to reduce ambiguity in the interpretation of the input text and thereby derive a “better” response to the input text).

It is believed that such an arrangement may be new and advantageous in its own right.

Thus, according to a third aspect of the present invention, there is provided a method of processing an input text message in an automated text message processing system in which are stored a plurality of exceptions to be matched against input text messages, each exception defining at least one text string that a text string derived from an input text message must match for the exception to be matched and having associated with it an answer function that is to be executed in the event of the exception being matched, the method comprising:

the system:

receiving an input text message;

searching sequentially through some or all of the stored exceptions for a match between a text string derived from the input text message and the text string or strings defined as matching to an exception; and

executing an answer function that is associated with a matched exception; wherein:

one or more of the stored exceptions have associated answer functions that will cause the system as a result of executing the answer function to use information derived from or associated with a part or parts of the input text determined by the matching process, together with information derived from or associated with another part or parts of the input text determined by the matching process and/or with information derived from or associated with a part or parts of a previous input text, to control the response of the system to the input text message.

According to a fourth aspect of the present invention, there is provided an apparatus for interpreting and responding to a text input message received by the apparatus, the apparatus comprising:

means for storing a plurality of exceptions to be matched against input text messages, each exception defining at least one text string that a text string derived from an input text message must match for the exception to be matched and having associated with it an answer function that is to be executed in the event of the exception being matched;

means for receiving an input text message;

means for searching sequentially through some or all of the stored exceptions for a match between a text string derived from the input text message and the text string or strings defined as matching to an exception; and

means for executing an answer function that is associated with a matched exception; wherein:

one or more of stored exceptions have associated answer functions that will cause the system as a result of executing the answer function to use information derived from or associated with a part or parts of the input text determined by the matching process, together with information derived from or associated with another part or parts of the input text determined by the matching process and/or with information derived from or associated with a part or parts of a previous input text, to control the response of the system to the input text message.

As will be appreciated by those skilled in the art, these aspects of the present invention can and preferably do include any one or more or all of the preferred and optional features of the invention, as appropriate. For example, the exceptions may include classes and wildcards in their definitions, etc., the response of the system may be to provide a response to the user and/or to update the system's internal state (e.g. stored data), etc.

In a preferred embodiment, only certain parts of the input text are subjected to processing in the manner of the present invention (where that is to be done). For example, even if the matching process divides the input text into plural parts, preferably only some but not all (e.g. two) of those parts of the input text are processed in the manner of the present invention. Most preferably, an answer function can and does indicate which part or parts (e.g. pair of parts) of the input text the relevant information (such as a set of attributes) should be determined for and then processed further, e.g. compared, in the manner of the present invention.

Similarly, although in many cases it may be that there are only two parts of an input text message that may interrelate and so could need resolving in the manner of the present invention, the Applicants have recognised that there may in some cases be inputs where, for example, plural terms in the input potentially imply constraints on other terms in the input.

Thus, in one particularly preferred embodiment, the present invention uses information derived from or associated with more than two parts of the input text (or a previous text input) to control the response of the system to the text input.

Most preferably, an answer function can indicate that information derived from or associated with a first part of the input text is to be used with information derived from or associated with another part of the input text (or a previous text input), and then the results of that processing is to be used with information derived from or associated with another (e.g. a third) part or parts of the input text (or a previous text input) (and so on, if desired) to then control the system's response. This would, in effect, and for example, allow the system to derive information from processing two (or more) parts of the input text, and then use that intermediate result with a further part of the input to get further information to control the system's response (and so on, if desired). Most preferably an answer function can indicate that the process is to be repeated (iterated) a number of times, e.g., taking the result of a first pair of parts of the input text, and using that result with a third part of the input text and so on.

For example, an input such as “When was Charles Darwin's father's wife born?” could be resolved by first using the process of the present invention in relation to “Charles Darwin” and “father” to constrain the interpretation of “father” to be “Robert Darwin” (effectively to assign the attribute “Robert Darwin” to “father”), and then processing “father” (but with the determined constraining attribute “Robert Darwin”), and “wife” using the process of the present invention to resolve “wife” to “Susannah Wedgwood” (as “Susannah Wedgwood” may be an attribute associated with “Robert Darwin”).

The process of using information in the manner of the present invention can be implemented as desired. In a preferred embodiment it is done by storing the relevant parts of the text message(s) as variables, and then carrying out the appropriate function using those variables (e.g. cross-referencing or intersecting information (attributes) associated with each variable, as discussed above).

Thus, for example, for the input “How heavy is mercury?”, “heavy” could be stored as one variable and “mercury” as another variable for this process. The system can then look-up the stored attributes of “heavy” and “mercury” and see if any match or correspond.

Thus, in a preferred embodiment, the present invention comprises steps or means for dividing an input test message into discrete parts using a matching process, assigning one or more of those parts to variables, and using information derived from or associated with those variables to control the response of the system, e.g., and preferably, by confirming and/or cross-referencing the information derived from or associated with the variables. Preferably the information is used to (try to) resolve ambiguity in the interpretation of a variable by the system, by applying a constraint in meaning derived from another variable.

This operation is preferably triggered by configuring an exception for the matching process to store the appropriate values as the appropriate variables (and the answer function associated with the exception to, e.g., then obtain and compare the information associated with those variables, as appropriate). Thus, in a preferred embodiment, an exception can indicate an input text part or portion that is to be stored (if the relevant set of predefined text strings is matched) and the identity of the variable in which the input text is to be stored, and in response to this, if the, e.g. exception, is matched, the system will store the relevant parts of the input text as the identified variables. For example, the class entry (member) that is actually used in an input text string that matches to a predefined text string indicating the class in question can preferably be and is preferably stored as a variable for further use in the process, etc.

In a preferred embodiment, there are plural variables available, each of which can be allocated a given part of an input text string as desired.

In a preferred embodiment, the process of the present invention uses information derived from or associated with a part or parts of the current input text, together with information derived from or associated with another part or parts of the current input text, to control the response of system to the input text message.

However, the Applicants have recognised that although in many circumstances any, e.g., ambiguity in the interpretation of an input text message for the purpose, e.g., of providing a response to that text message may be resolvable using information derivable from that message itself, in other cases that may not be possible. An example of this may be, for example, where an input uses an anaphor, such as a pronoun, such as his or “its”. However, such a term may be resolvable from the user's previous inputs.

Thus, in a preferred embodiment, a record of a previous interaction (or interactions) with a user (or users) is maintained. This will allow, for example, context information from a previous interaction to be used to assist in interpretation of a later interaction.

For example, if an input or answer function referred to “King Charles”, then “King Charles” could be stored in a variable that is to be referred to, for example, if a later input from the same user uses a pronoun such as “he” or “his” to thereby allow the system to interpret the later input of “he” or “his” as referring to “King Charles” (in this case).

Moreover, the Applicants have recognised that “historical” information from a user's previous interactions or inputs, such as, and preferably, the values stored in variables by previously matched exceptions, as discussed above, may be used in the process of the present invention. For example, in the case of the input “How heavy is mercury”, if the interaction history indicates that the context of the interaction is “planets” (e.g. from information derived from or associated with a previous input including the part (term) “mars”), the system could; e.g., use that information to constrain the interpretation of “mercury”.

Thus, in a particularly preferred embodiment, the present invention uses information derived from or associated with a part or parts of the current input text, together with information derived from or associated with a part or parts of a previous input text, to control the response of system to the input text message. Most preferably, the present invention uses information derived from or associated with a part or parts of the current input text, together with information derived from or associated with a part or parts of a previous input text and with information derived from or associated with another part or parts of the current input text, to control the response of system to the input text message.

Information derived from or associated with a part or parts of more than one previous input text could be used if desired.

In a particularly preferred such arrangement, the information from the user's previous interaction(s) is used to try to apply constraints that can be derived from that information to the processing of the current text message, as discussed above, most preferably to try to reduce or resolve ambiguity in the user's present input.

Most preferably any constraints derived from a previous text input are applied before using information derived from or associated with one part of the current input message together with information derived from or associated with another part of the current input message to control the system's response. Thus, in a particularly preferred embodiment, the present invention comprises steps of or means for using information derived from a user's previous input or inputs to constrain the processing of the user's current input. In effect, the use of the information derived from the user's previous input(s) can be thought of as applying a “memory filter” to the processing of the current input, prior to using the current input to determine the system's response to that input.

In these arrangements, it would be possible to use, e.g., information derived from any desired number of a user's previous interactions. For example, information derived from only the immediately preceding input of the user could be used. In a preferred embodiment, information from a predetermined number, preferably two, of the user's preceding inputs is used in this manner.

Where information from more than one previous input is to be used to, e.g., constrain the processing for the current input, then preferably the more recent previous inputs are given more weight, and most preferably replace or override any less recent inputs. Thus, for example, a constraint derived from the immediately preceding input is preferably used instead of a constraint from a less recent input (but if there is no relevant constraint from the immediately preceding input, a constraint derived from a less recent input may be and is preferably used).

In a particularly preferred embodiment, if the processing for the user's current input uses a constraint from the immediately preceding input a different response is provided to the user than if a constraint from a less recent input is used when processing the current input.

In a particularly preferred embodiment of these arrangements of the present invention, a user's current input is first processed using any desired information (e.g., and preferably, constraints) from the user's previous input(s) but if the user's current input cannot be appropriately processed when using that information (e.g. with those constraints in place), the current input is processed again but without using any information (without applying any constraints) derived from the user's previous input(s).

For example, in the case of the dialogue inputs

### Who was the god Athene?

How heavy is Mercury?
processing the first input may determine that object in question is constrained to be a “god”. Thus, applying a constraint based on the user's history will initially limit the processing for the second input to only considering “god” as a possible meaning for “mercury”. This processing will fail since “heavy” does not correspond appropriately with the meaning the god Mercury. In this situation, the processing is then re-run without the “history” constraint. Behaviour may then be as described above, where the processing identifies either element or planet as suitable candidates for “mercury”, resulting in a response in the form of a clarification step with the user.

The information relating to a user's previous input(s) may be stored as desired. Preferably this is done by storing appropriate variables, etc., as discussed above. In a particularly preferred embodiment, the system maintains a set of data stores (short term memories) that store information relating to the user's current and previous inputs. Most preferably there are three such data stores, one for storing information relating to the user's current input, one for the user's immediately preceding input and one for the input before that. Preferably the stores are configured on a first-in, first-out basis, so that the user's current input passes to the store for the immediately preceding input (and so on) once the current input has been processed.

In a preferred embodiment, the exceptions defined for the matching process include as appropriate commands and functions to store information derived from the user's input in the appropriate data store and variables, etc. (in practice the data store and variables for the current input) in the event of a match. The information that is stored in the data store may be selected as desired, and preferably comprises, as discussed above, at least selected parts of (e.g. matched terms of) the user's input.

In a particularly preferred embodiment, the information that is stored includes information that is derived from processing the user's input and not solely or simply text taken from that input. For example, and preferably, constraints (e.g. attributes) associated with a term or terms identified in the user's input may be derived and stored in the data store for that input, and/or the resolved interpretation of a potentially ambiguous term in the user's input may be stored. Thus, for example, and preferably, the data store for a user's current input may initially store some or all of the text from the user's input as variables, but then that information may be replaced by, or, preferably, supplemented with, information derived from processing of the user's input.

For example, preferably information discovered as part of the processing of a user's input is stored. For example, an input such as “What is the largest planet” could be processed to derive the answer “Jupiter”, and “Jupiter” stored for use, e.g., to answer subsequent inputs such as “What is its diameter”. In this case it is useful to store information (“Jupiter”) provided as, or associated with, the output to the user.

Thus, in a preferred embodiment, the information that is stored may, and preferably does, include information that is derived from or associated with an output provided to a user's input and/or previous input or inputs. This data need not be the response provided to the user per se (although it could be), but could, e.g., also or instead be data associated with or derived from that response.

A single piece or multiple pieces of such data could be stored, as desired.

In a preferred embodiment, and as discussed above, each data store stores one or more variables each representing or corresponding to a part (a text string (a word or words)) identified in the user's input (by the matching process), together with additional information to be associated with that part (text string) of the user's input (which information may be, and preferably is, derived from processing the user's input). Preferably each variable has associated with it one or more of an “object” (which may be a single item or items derived from the user's input), an associate (an object or objects associated with the “object”), a constraint (which may be a single constraint or plural constraints) to be associated with the “object”, and the identity of the class or classes used when the “object” was matched. Other arrangements would, of course, be possible.

It is believed that an arrangement in which the processed results of a user's input are stored for use when processing a user's subsequent inputs may be new and advantageous in its own right. For example, it may still be useful in systems where the particular text message processing of the present invention described above is not used.

Thus, according to a fifth aspect of the present invention, there is provided a method of processing an input text message in an automated text message processing system, the method comprising:

the system:

receiving an input text message;

using a matching process to attempt to match a part or parts of the input text to a predefined text string or strings; and

performing an operation in response to the results of the matching process; wherein the method further comprises:

storing information derived from the user's input;

replacing or supplementing the stored information with information derived from processing of the user's input; and

using the stored information when processing another input text message from the user.

Thus, according to a sixth aspect of the present invention, there is provided an apparatus for processing an input text message in an automated text message processing system, the apparatus comprising:

means for receiving an input text message;

means for using a matching process to attempt to match a part or parts of the input text to a predefined text string or strings;

means for performing an operation in response to the results of the matching process;

means for storing information derived from the user's input;

means for replacing or supplementing the stored information with information derived from processing of the user's input; and

means for using the stored information when processing another input text message from the user.

As will be appreciated by those skilled in the art, these aspects of the present invention can and preferably do include any one or more or all of the preferred and optional features of the present invention described herein, as appropriate.

The present invention may be implemented as desired. In a preferred embodiment there is a processor or processing platform that will receive the input text messages and process them against the (sets of), e.g., exceptions. This processing platform may itself store tables of predefined text strings and sets of, e.g., exceptions, tables of classes, etc., and/or may have access, e.g., over a network, to such a store. It may also include appropriate text string sorting/ordering, class construction, user history storing, system logging, etc., functionality, as discussed above. This processing and functionality may be arranged on a single platform or in a distributed fashion, for example. Also, the sorting, compilation, etc., of the predefined text strings (e.g. exceptions), etc., may be carried out on a separate computer and then loaded onto the system for use, if desired.

The system preferably also includes and/or has access to, one or more databases and/or knowledge tables for storing data that may be used, e.g., when testing predefined text strings, providing answer functions (responses), etc. It can preferably similarly include and/or access maths or other function engines as necessary.

In use of such a system, a user will send a text message which will then be communicated to the text message processing system in an appropriate fashion. The text message processing system will then pre-process the input text message to a derived form (or forms) as discussed above (if required) and submit the input text message, or the derived form or forms of the input text message, as appropriate, to the text string matching process (engine) which will then test the or each form of the input text against a stored set or sets of predefined text strings (e.g. exceptions) until a match is found. An answer function associated with the matched text string(s) will then, e.g., be executed.

As will be appreciated by those skilled in the art, although the present invention has been described above with reference to the processing of an input text message, in practice the system and method of the present invention will be operable to receive and process plural text messages, and text messages from plural different users. In particular, the system can preferably process a series of text messages from a user, so as to, for example, provide a dialogue with a user.

Similarly in a preferred embodiment, the system of the present invention supports a plurality of services and/or applications that may be accessed via text messages in the manner of the present invention. Such different services and applications may have their own sets of predefined text strings (e.g. exceptions) and classes, etc., and/or they may share some or all of their predefined text strings and classes with other services and/or applications. Preferably a user can indicate which service or application they want, for example by sending a text message to a particular number or short code associated with that service or application. Alternatively, or additionally, there could, e.g. be a single number or short code that can be used to access plural services and/or applications, with, e.g., a natural language interface then being used to select the particular service or application required. Other arrangements would, of course, be possible.

The present invention may be used in any system where (automated) text interaction may be advantageous, such as in personal or commercial information, service and/or application systems where users may desire to obtain information or interact with the system via text messages. It may be used in any system and situation wherein textual input may be supplied by a user to solicit an automated action, such as a text reply. Equally, the text input may be generated by or from the user in any suitable manner, such as directly in the form of text, or from the output of a speech to text interface, etc.

A particularly preferred application of the present invention is to provide automated services and applications in telephony networks and in particular in mobile telephony networks and systems. Such telephony systems, particularly mobile systems, typically already have well-established facilities for communicating via short text messages and so the present invention can be particularly advantageously applied in such systems.

Thus, in a particularly preferred embodiment, the present invention comprises a mobile telephony system that includes the apparatus of, or that is operated in accordance with the method of, the present invention. Similarly, in a preferred embodiment, the text messages are in the form of mobile telephony (short) text messages, such as, and preferably, SMS messages.

Thus, according to a seventh aspect of the present invention, there is provided a system for providing an application or service that may be accessed and used via the sending of text messages in a mobile telephony network, the system comprising:

a text message processing system for the application or service comprising:

means for receiving an input text message;

means for processing an input text message using a matching process to divide the input text message into one or more parts; and

means for using information derived from or associated with a part or parts of the input text determined by the matching process, together with information derived from or associated with another part or parts of the input text determined by the matching process and/or with information derived from or associated with a part or parts of a previous input text, to control the response of system to the input text message; and

the system further comprising:

means for identifying a text message sent by a user that is intended for the application or service and for directing the text message accordingly to the text message processing system for the application or service.

According to an eighth aspect of the present invention, there is provided a method of providing an application or service that may be accessed and used via the sending of text messages in a mobile telephony network, the method comprising:

the mobile telephony network identifying a text message sent by a user that is intended for the application or service and directing the text message accordingly to a text message processing system for the application or service; and

the text message processing system for the application or service:

receiving the text message;

using a matching process to divide the input text message into one or more parts; and

using information derived from or associated with a part or parts of the input text determined by the matching process, together with information derived from or associated with another part or parts of the input text determined by the matching process and/or with information derived from or associated with a part or parts of a previous input text, to control the response of system to the input text message.

The other above described aspects of the invention can similarly be applied to and used in a mobile telephone network and thus according to further aspects, the present invention extends to corresponding methods and apparatus for providing an application or service that may be accessed and used via the sending of text messages in a mobile telephony network in accordance with the third, fourth, fifth or sixth aspects of the present invention described herein.

As will be appreciated by those skilled in the art, all of these aspects and embodiments of the present invention can and preferably do include any one or more or all of the preferred and optional features of the invention described herein, as appropriate. Thus, for example, the predefined text strings and matching process can preferably be structured as discussed above, the information derived from or associated with the parts of the text message can be and is preferably determined and used as discussed above, and the system may include, e.g. knowledge tables, access to external databases, etc., as discussed above.

Most preferably the invention is implemented in a GSM or 3G mobile telephony system, and the text messages that are sent are SMS (Short Message Service) messages.

Where the invention is implemented in a GSM/3G system, then preferably so-called “direct” delivery of SMS messages to the system is used, so as to avoid the indeterminate delays which are inherent with an SMSC (Short Message Service Centre)-based architecture.

As will be appreciated by those skilled in the art, all of the above aspects and embodiments of the present invention can and preferably do include any one or more as all of the preferred and optional features of the invention described herein, as appropriate.

The methods in accordance with the present invention may be implemented at least partially using software e.g. computer programs. It, will thus be seen that when viewed from further aspects the present invention provides computer software specifically adapted to carry out a method or the methods herein described when installed on data processing means, a computer program element comprising computer software code portions for performing a method or the methods herein described when the program element is run on data processing means, and a computer program comprising code means adapted to perform all the steps of a method or of the methods herein described when the program is run on a data-processing system.

The invention also extends to a computer software carrier comprising such software which when used to operate a communications system comprising data processing means causes in conjunction with said data processing means said system to carry out the steps of a method or of the methods of the present invention. Such a computer software carrier could be a physical storage medium such as a ROM chip, CD ROM or disk, or could be a signal such as an electronic signal over wires, an optical signal or a radio signal such as to a satellite or the like.

A number of preferred embodiments of the present invention will now be described by way of example only and with reference to the accompanying drawings, in which:

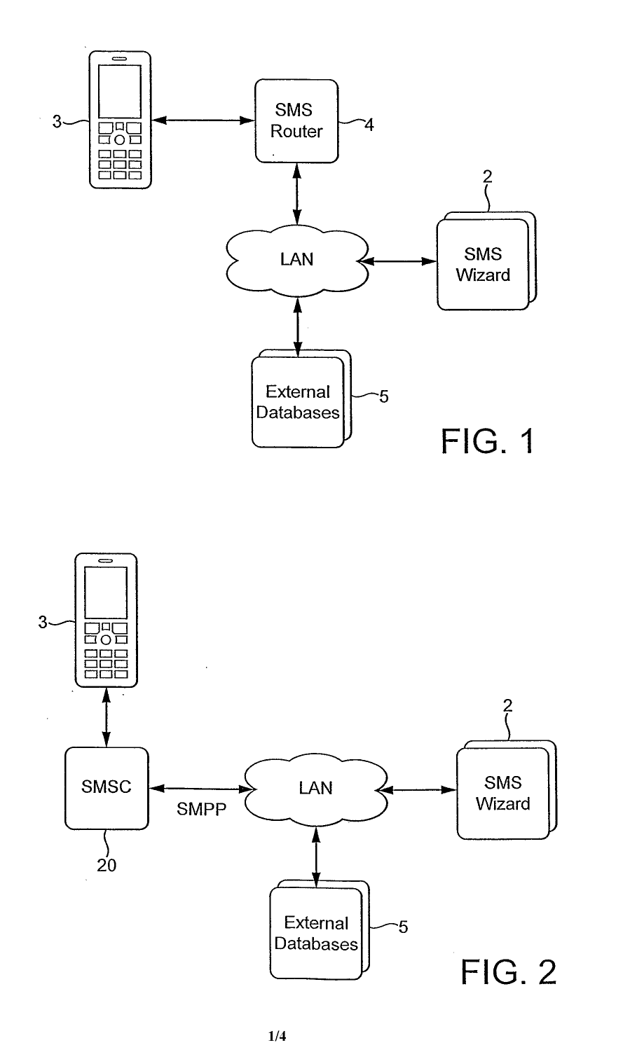

FIG. 1 shows schematically an implementation of the present invention in a telephone network;

FIG. 2 shows schematically an alternative telephone network configuration for implementing the present invention;

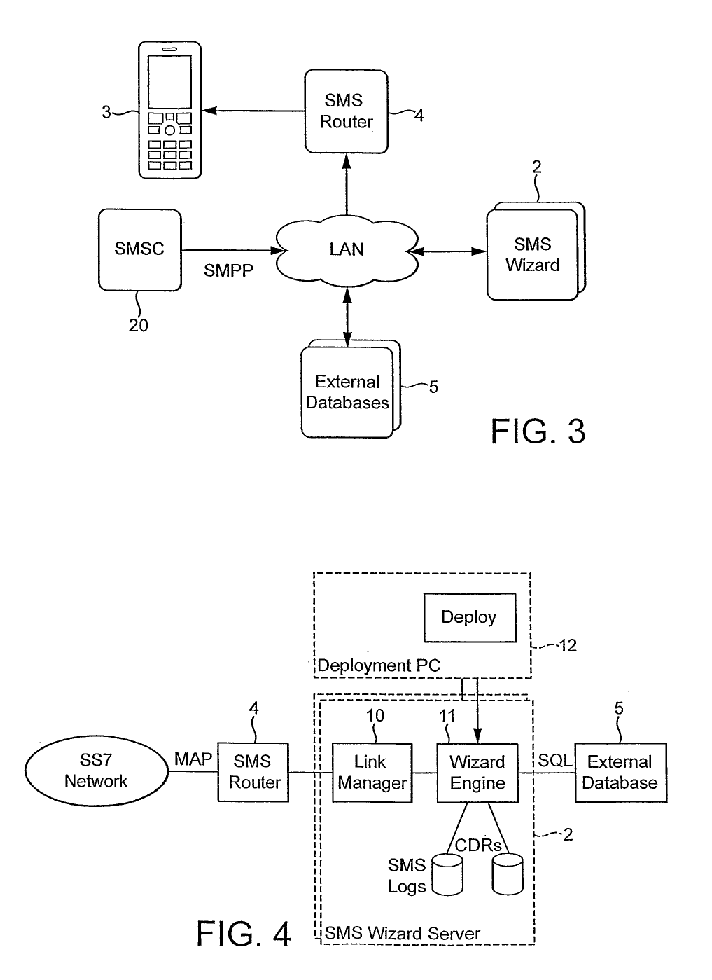

FIG. 3 shows schematically a further alternative telephone network configuration for implementing the present invention;

FIG. 4 shows schematically some components of the system of FIG. 1 in more detail;

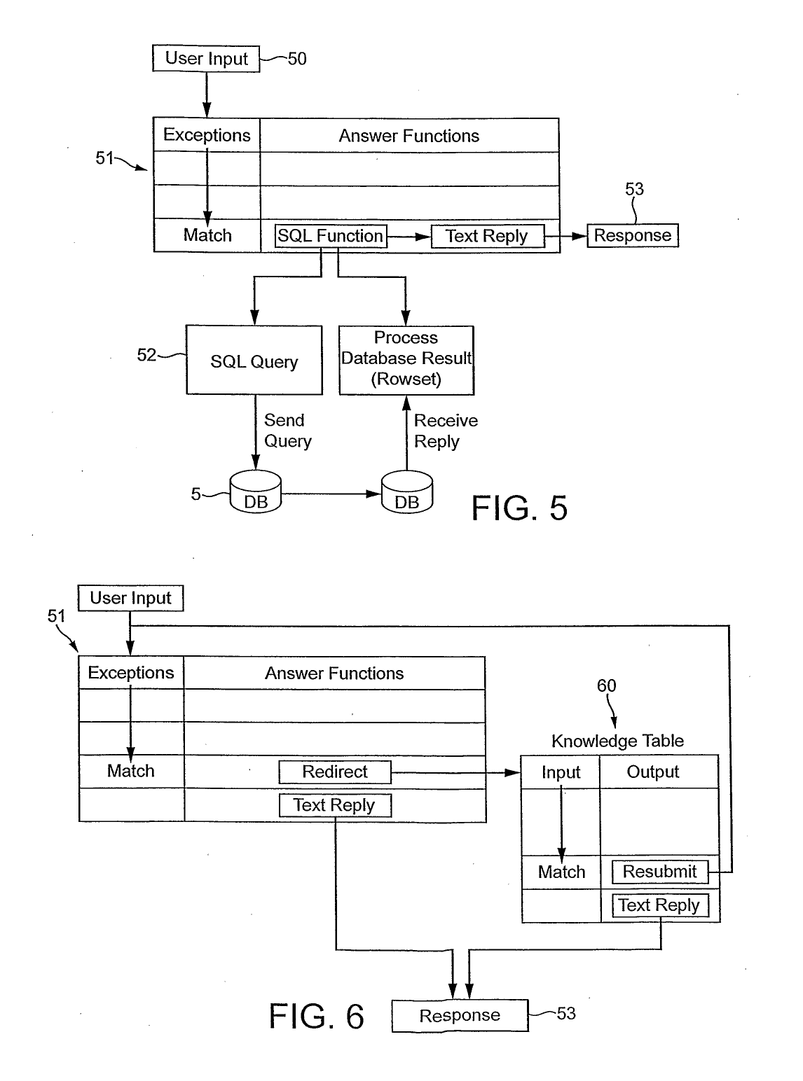

FIG. 5 shows an example overview of exception matching;

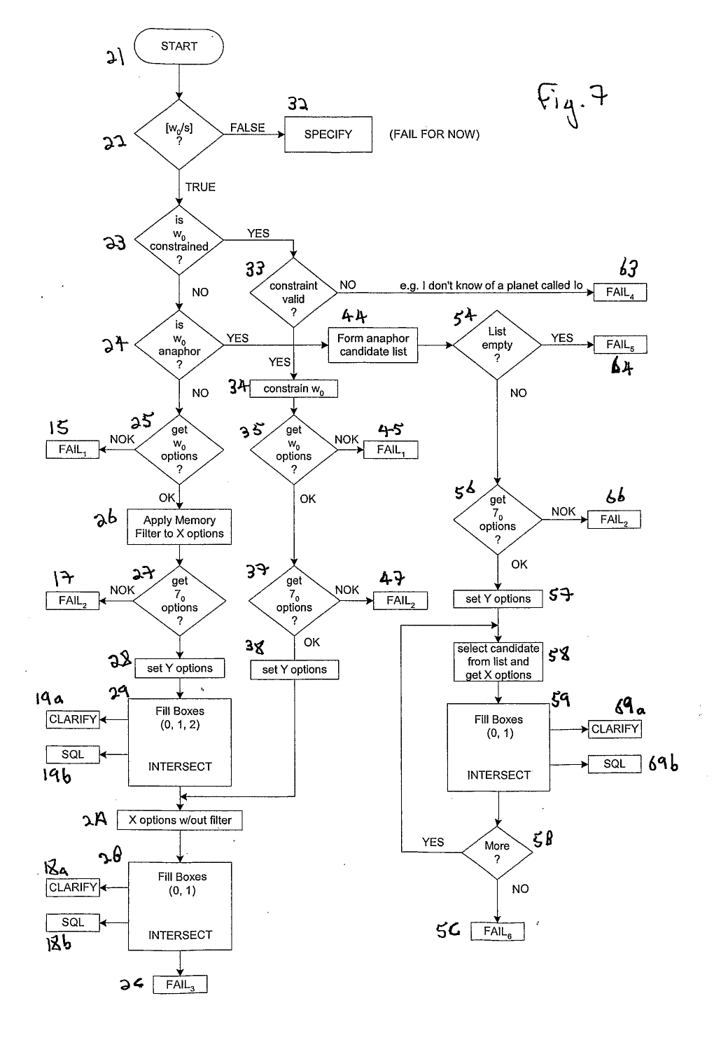

FIG. 6 shows a further example overview of exception matching; and

FIG. 7 is a flowchart showing schematically the operation of an embodiment of the present invention.

FIG. 1 shows schematically the implementation of a preferred embodiment of the present invention in a mobile telephone network.

In this embodiment, a server-based system 2, referred to as an SMS Wizard, is able to receive input text messages, such as SMS messages, sent by users via their mobile telephone handsets 3, and process and respond to those text messages in the manner of the present invention.

The SMS Wizard 2 may be used, for example, for applications including customer registrations, surveys, promotions, account queries and service discovery, as well as general customer care queries. SMS applications involving application automation could for example include a natural language text interface to a commerce application responsible for accepting parking fees or other tolls.

In the arrangement shown in FIG. 1, the SMS Wizard 2 is connected to the mobile telephone network using SS7 Mobile Application Protocol (MAP) via an SMS Router 4. This method of connection avoids the indeterminate delays which are inherent with an SMSC-based SMS architecture and enables provision of the fastest response and highest quality of service. Importantly, as is known in the art, when connected in this way, when ‘Message sent’ is displayed on the handset 3, it means that the message has reached the SMS Wizard 2, not just that it has been stored in an SMSC. The SMS Wizard 2 incorporates an input buffer to accommodate traffic peaks that may be associated with, for example, television promotions.

Thus, in the arrangement shown in FIG. 1, the SMS Router 4 has an SS7 MAP or SIGTRAN interface to the mobile telephone network and receives Mobile Originated (MO) SMS messages. It identifies messages destined for SMS Wizard 2 services, which for example in a customer care application would be typically addressed to the same short codes that are used for voice customer care services, and delivers them immediately to the SMS Wizard 2, preferably over TCP/IP.

The SMS Wizard 2 interprets the received message (this will be discussed in more detail below) and may pass an appropriate reply to the SMS Router 4, which delivers a Mobile Terminated (MT) SMS message directly to the handset 3 via an SS7 MAP interface. The system's customer records may also be updated in response to the received input message, as appropriate. As the reply is virtually ‘immediate’, the handset 3 will normally be available to receive the SMS message; if it is not able to, the system performs automatic retries according to a pre-determined schedule. Connection of the SMS Wizard 2 via an SMS Router 4 also enables provision of advanced or alphanumeric services.

As shown in FIG. 1, there are in fact plural SMS Wizards 2. The SMS router 4 delivers SMS messages to the SMS Wizards 2 based on the User's CLI. This ensures that the same SMS Wizard receives all the traffic for a CLI. This is important because, as will be discussed further below, an SMS Wizard 2 may store dialogue history which can affect the response to the User. (Alternatively, a shared, e.g., central, database could be used to store the user data, etc.)

In the present embodiment, the SMS Router 4 routes traffic to a particular SMS Wizard 2 based on the last two digits of the CLI. This makes it possible to configure the SMS Router 4 to distribute traffic as desired between multiple SMS Wizards. This allows the SMS Wizard system to grow incrementally. The table below gives examples of such configurations:

| Number of SMS Wizards | SMS Router rules (last digits of CLI) |
|---|---|
| 1 | 00-99 |
| 2 | 00-49, 50-99 |
| 3 | 00-33, 34-66, 67-99 |
| 4 | 00-24, 25-49, 50-74, 75-99 |
| 5 | 00-19, 20-39, 40-59, 60-79, 80-99 |

If one of the SMS Wizards fails, the SMS Router 4 is configured to send this traffic to a fallback SMS Wizard.

The SMS Wizards 2 also have access to internal Knowledge Tables and external databases 5. Applications can be entirely self-contained, using internal Knowledge Tables, or they can utilise external databases for information such as account details. Data can be automatically extracted from a received message and written into an external database, for example registration information.

The various components of the system are linked to the SMS Wizards 2 by suitable network connections. FIG. 4 shows this in more detail.

As shown in FIG. 4, an external databases extension allows the SMS Wizards 2 to send queries to external databases 5 using a database access protocol. The database 5 may alternatively be accessed indirectly via a middleware application. The database queries can be in any language supported by the database or middleware provider. In a preferred embodiment the protocol could be OLE DB, ODBC or SQL.

A Link Manager component 10 manages connections to the telephone network and buffers incoming messages, while the Wizard Engine 11 component provides the processing of text messages and the generation of output. A deployment interface 12 for the environment is also shown that allows knowledge data to be loaded onto the SMS Wizards 2.

In the present embodiment, an SMS Wizard 2 fully processes each input message either itself or in conjunction with access to an external database or system. Whilst waiting for a reply from an external system, the SMS Wizard 2 can continue to process other input messages.

However, if a reply from an external system is very slow to arrive (there is preferably a maximum timeout for all external database queries), it is feasible that the same user could have sent in another input message, and for that to have been processed.

It is possible that this could lead to unexpected behaviour within a service, as the second message might use a storage variable, before the first message had completed its work on that variable. In some circumstances, this could lead to incorrect responses and incorrect information being stored in variables.

Each SMS Wizard 2 is therefore configured in this embodiment to ensure that each message from a given user is processed in the correct order by queuing up any further messages from the same user until the first message has completed. This avoids the possibility of a user's variables becoming corrupted by subsequent messages. Thus, messages from a given user are processed one at a time, and a second message is not accepted until the first message has been fully processed. This makes it impossible for messages to adversely interact under any circumstances, though of course processing of a subsequent message may be delayed until the first message has completed.

The SMS Wizards 2 maintain system logs. This makes it easy to identify aspects of a service which could be improved, since logs of requests that could not be interpreted or satisfied can be reviewed by the system operator and used as input to subsequent revisions of knowledge data or Exceptions.

Other connection and communication arrangements would be possible.

For example, as shown in FIG. 2, SMPP may provide a suitable means of connection to the SMS Wizard 2 via the host interface of an SMSC 20 (or a proprietary equivalent).

A further alternative connection option is illustrated in FIG. 3. In this case, the inbound messages to the SMS Wizard 2 pass through the SMSC 20 and are delivered via SMPP. However, replies to the handset 3 are delivered directly via an SMS Router 4. This ensures that output messages are delivered immediately if possible, rather than being subject to indeterminate delays through the SMSC, and also enables partial provision of alphanumeric services, i.e. alpha addressing for output messages.

When a text message arrives at an SMS Wizard 2, the destination number used by the sender 3 is used to determine which service to run by means of a lookup into a service table. If there is no match then a default service is run on the SMS Wizard 2.

The basic principles of the input text processing of the present embodiment will now be described, and then the particular operation in the manner of the present invention will be described in more detail.

In the present embodiment a given service or application supported by the SMS Wizard 2 has associated with it a plurality of exceptions, each exception defining a set of predefined text strings and having associated with it an answer function to be performed in the event of a match to the particular set of text strings. These exceptions thus, in effect, define a set of matchable inputs from a user and corresponding (answer) functions to be performed in the event of the particular input.

In the text matching process of the present embodiment, an input text message is tested sequentially against a set of stored exceptions until a match is found (or no match at all is found). Once a match is found, an answer function associated with the matched exception is executed. If no match is found, a default match is assumed.

Each exception has defined for it, inter alia, a text string or strings that a text string derived from the input text message must match for the exception to be matched, and has associated with it a corresponding answer function for the exception.

An exemplary exception, together with its associated answer function is shown below:

| Exception | Answer Function |
|---|---|
| my name is john | Hi John. |

This exception will be matched by an input containing only the string of text “my name is John” and will trigger as its answer function the sending of the text “Hi John.” to the user who sent the input message.

In the present embodiment, exceptions are case insensitive and their text looks exactly like user input text that has been pre-processed to allow the removal of variances caused by white space, character set, accenting and case. In the present embodiment, all exceptions are written in lower case.

The SMS Wizard 2 pre-processes the received input text in order to convert it to a standard character set (GSM SMS is normally only 7-bit), substitutes disallowed characters with space, removes redundant whitespace and converts the entire string to a consistent case to form an input text string to be matched. The SMS Wizard 2 then uses matching to examine each exception sequentially; if a match is found between an exception and an input string then the corresponding answer function is executed. It would also be possible, e.g., to process the received input text to plural derived forms, each of which is then input to the matching process, as discussed above.

The matching process is algorithmic, since as well as containing literal text the exception syntax can include, as will be discussed further below, Wildcards (variables), Class Identifiers and “Super” Class Identifiers. These constructs can absorb variable numbers of characters from the input string in order to allow the remainder of the string to match the remainder of the exception. Generally, matching is done from left to right.

Simple exceptions (sets of text strings), that require a literal match with an input test message, may be defined, such as—

hello

what is your name

i have a new address

Each exception is associated with an answer function that is executed if the exception matches. In the present embodiment, the answer function associated with an exception can have many capabilities. For example, an answer function can—
Access an external database
Launch an external program
Forward the original or a modified input message transparently to a different destination address
Generate two or more outgoing messages to different destinations for one input message
Cause an external operation to be performed, such as an electronic payment action
Cause the match text to be modified and matching to restart or continue
Cause a Call Detail Record to be written to a log
Set the value of one or more temporary or permanent variables (Wildcards)
Cause a lookup to a Knowledge Table or an external database.
Create a text output from any combination of fixed text, variable (Wildcard) Contents and Knowledge Table lookup result.
Return text output to the sender
Modify internal system state.

An answer function can contain a number of functions to be executed in the event of a match. In the simplest case, an answer function may contain literal text to be output. In a telecommunications application, answer functions may also for example be used to ‘no reply’, to send a text message, to send a ‘WAP push’ message, to send an MMS message, to send an Instant message or to initiate a Voice or Video Call.

A reply sent to a user may contain several components, such as fixed text, content based on the user input, and variable information from internal or external databases.

Answer functions may also contain functions, for example the function [n/empty] which determines whether the variable (Wildcard) n is empty and then conditionally executes an associated part of the answer function. Similarly engines may be used in answer functions to provide specialised resources which are not suitable for Knowledge Tables. For example a Maths Engine can be used to perform calculations or answers relating to mathematical queries. Answer functions can also contain text manipulation functions, for example pluralizing, singularising, or switching gender or person. For example a question phrased with ‘I’ might require an answer phrased with ‘you’.

The answer function may define literal text to be returned to the user and it may also contain variables populated by the exception during the present matching operation or previously.

Several functions are available for substituting or changing (e.g. deleting) text in the input string in order to create an output string. Also an answer function can specify that its output should be resubmitted to the exception matching process either recommencing from the beginning or resuming from the next exception or elsewhere. This is particularly useful for reformatting an input string to for example remove redundant or unnecessary words, to rationalise a number of variants of a word or phrase into a single standard variant, or to correct common errors.

It is also possible to jump to a specific exception to continue processing.

In this way iterative processing of a text string is possible, where some exceptions are responsible for standardising the form of a query, while others generate output or actions for responding to the user's request. This can result in very powerful text processing capability with relatively few exceptions.

FIG. 5 shows an example overview of exception matching. User input 50 is matched against a list 51 of exceptions (predefined sets of text strings) sequentially until a match is found, and then the corresponding answer function is executed. If no explicit match is found, then the system automatically executes a default answer function. In this example the matched answer function contains an SQL query 52, which causes an external access to a database 5. When the database reply is received, processing is resumed on this exception match and the remainder of the answer function is executed, which comprises some text to be output 53 to the user.

FIG. 6 shows a further example overview of exception matching. In this example the matched exception has an answer function that contains a redirect to a Knowledge Table 60. The answer function specifies the input that is to be matched by the Knowledge Table, typically by providing one or more Wildcards (variables) that have been assigned during previous exception matching, and the Knowledge Table maps this input to an output that can be used in completion of processing of the present answer function, in generating a response 53 to the user, or in a string to be resubmitted to the exception matching process.

In the present embodiment, exceptions and answer functions can include variables known as Wildcards that can be used to match parts of the user input and to hold the matched text for later use. An important use of such Wildcards is that they are instantiated during matching, and then the instantiated value can be used during further matching within the same exception, or during processing of an answer function. This allows the instantiated information from a successful match to be passed to the associated answer function. For example, the following exception uses Wildcard (variable) 9 to capture any text submitted by the user following the string ‘my name is’.

| Exception | Answer Function |
|---|---|
| my name is {9} | Hi {9}, I'll remember that |

In this example, the input

My name is Levi

Would match to this exception, and result in the output

Hi Levi, I'll remember that

In the present embodiment, although the matching is done all in a consistent case, the text stored in a Wildcard has redundant white space removed but is in the original case as entered by the user.

In the present embodiment, exceptions can define sets or groups of things (entries), any one of which if present will match to that part of the exception (that text string in the set of predefined text strings making up the exception).

This may be defined within an exception as a list of entries with separators between, such as in the following exception:

what is the {1/area|size} of france

In this exception the construct in { } defines the alternatives that will match to that text string part of the exception. In this example the construct in { } will match to either ‘area’ or ‘size’ and place the matched one into variable (Wildcard) 1. This exception form can be viewed as being an “In-line class” and allows the efficient matching of alternative strings using a single exception.

It is also possible in the present embodiment to define data structures or classes that define a set or group of members or allowed matches to the class, and which can be referenced in an exception by the inclusion of an identifier for the class in the exception. Such classes, can be used, for example, to define a large group of similar entries. A class is primarily used as a restriction on the text that may be matched during exception matching.

The use of such classes allows indirection, and provides a very powerful means of increasing the efficiency of exceptions. For example, by the use of classes, an enormous number of possible input strings can be matched by relatively few exceptions.

Such classes can be defined, for example, by the system developer or provider.

A simple example of a developer-defined class might be a list of country names, which could be defined as follows—

Class country
france[France]
italy[Italy]
uk[The United Kingdom]
united kingdom[The United Kingdom]
.
.
.

The optional entry suffix in square brackets is additional information associated with the class entry and is referred to in this embodiment as the “Root”. This will be discussed further below.

For this class, the class identifier is “country” and it could be used in an exception as in the following example—

what is the capital of {1/*country}

In the preferred syntax used here, the “1” is an arbitrary Wildcard (variable) number, the “/” is a separator and the “*” indicates that the following term or token is a class identifier. The user input matches this exception text string only if the input text following “what is the capital of” matches one of the entries in the class “country”. If a match is found, the matched entry is assigned to Wildcard (variable) 1.

It is also possible for a class to include other classes as or among its members. In the present embodiment such a “super” class is referred to as a star class and represented by *Class and is a named set of classes. For example the *Class “*world” could comprise—

Star Class *world
Europe
Asia

referring to two classes called Europe and Asia, each of which defines lists of associated countries. An example of the *Class “*world” in use to define a text string forming part of an exception is as follows—

. . . {1/**world/21} . . .

which will match to any entry of a class whose name is listed in the *Class identified as “world”, place the matched entry into Wildcard 1, and place the matched class identifier into Wildcard 21.

In the present embodiment exceptions may also define class exclusions, whereby exception syntax can specify that a match may be required to exist in one of a number of classes but not exist in a number of other classes. This is a powerful technique for reducing the number of exceptions required to cover a given domain, for example matching to an address.

In the present embodiment, as discussed above each class entry may have associated with it some additional information (a “Root”). The class entry preferably defines a Root explicitly as a suffix to the class entry.

In the present embodiment, each Wildcard (variable) also has an associated shadow Wildcard which is automatically allocated the Root of a matched class entry when a class match is made and allocated to a Wildcard. Shadow Wildcards can provide a powerful form of data reduction by allowing for variability in the input.

In the present embodiment, certain kinds of class may use multiple tokens in the Root, and the Root entries may themselves be class identifiers. As an example of how powerful this can be, the following simple exception classes can be used as an illustration—

Consider Fragments of Two Classes:

Class cat
Manx
Tabby
.
.
.

Class language
Manx
French
.
.
.

and a class “wordtype” that uses the Root of its class entries to identify all of the classes in which defined words occur.

A fragment of this “wordtype” class would look like this—

Class wordtype
french[language]
Manx[cat|language]
Tabby[cat]
.
.
.

Preferably this class “wordtype” is automatically constructed by the system from the classes of the system, e.g., at compile time and/or as a background task while the system is in use. This may be done, e.g., by the system traversing the whole of the class data and then generating the class “wordtype” effectively as a reverse look-up table from the class data.

If Wildcard 11 is assumed to be the shadow Wildcard for Wildcard 1, then the following exception—

is {1/*wordtype} a {2/{11}}

can now be used to match to the question

Is Manx a language

allowing the answer function to return a positive response.

This works as follows. The literal “is” is matched first. Then the class “wordtype” matches to “manx”, and so “manx” is placed in Wildcard 1, and the shadow Wildcard 11 is automatically loaded with the Root of “manx” in the class “wordtype”, which is “cat|language”. The literal “a” matches next, and finally “language” matches with the value of Wildcard 11 (as it contains (the in-line class) “cat|language”). The matching token “language” is placed in Wildcard 2. The whole exception has now matched, and so the corresponding answer function is executed.

As discussed above, the system of the present embodiment also includes a number of Knowledge Tables. These are tables comprising lists of paired information, inputs and outputs, which answer functions can access and derive outputs from. Following the previous example, the answer function could redirect to a Knowledge Table of country attributes, where the inputs are attribute and country names and the outputs are suitable output text for transmission to the user, as illustrated in the following example extract from a possible Knowledge Table—

| Input | Output |
|---|---|
| capital/france | The capital of France is Paris |
| capital/italy | The capital of Italy is Rome |
| . | |
| . | |
| . | |
| Population/france | The population of France is |
| | 59.6 million |
| Population/italy | The population of Italy is 57.7 |
| | million |
| . | |
| . | |
| . | |

Alternatively, or additionally, a Knowledge Table output may comprise text to be resubmitted to the exception matching process, or redirected to a further Knowledge Table.

In the present embodiment, an exception can, as well as defining a matching set of a text string or strings, include some other condition or criteria that must be met in relation to an input text message for the exception to be matched.

In the present embodiments these conditions or criteria are referred to as “gates” and are used to specify a condition (or conditions) that must be satisfied before the rest of the exception is tried. If the “gate” condition is not met, the rest of the exception is ignored. Thus, a “gate” is a conditional test that, in effect, determines whether an exception is tested or skipped in the matching process.

“Gates” can be thus used as a mechanism for providing topic focus or context in a dialogue. This is desirable if, for example, the user responds with a natural but ambiguous answer such as “yes”, where memory of the previous context may be desirable for correct interpretation.

In the present embodiment “gates” are denoted at the beginning of an exception, as follows:

[Gate condition] main part of the exception

In this exception “[ ]” denotes a gate condition to be tested to determine if the main part of the exception should be considered or not. An exception may have multiple gates, and if any of the “gate” conditions are failed, the exception is ignored.

In the present embodiment gates can set conditions relating to, inter alia, the user's telephone number (such that only a given user or users will be allowed access to the exception in question), the destination number, and/or the time and/or date.

In the present embodiment, a gate can also be used to test whether a particular variable, such as a Wildcard, has been set to a particular value (e.g. text string) or not. This is done by identifying the variable in question and the value (e.g. text) it is to have to match the gate in the gate condition.

For example, the required value of the variable could be set to something that represents the relevant history and/or context for the exception to be required, such that the exception will only be used if the appropriate context or history is active (since in that case the variable should have the appropriate value).

This allows an exception to be matched only if, for example, it is appropriate in the light of the previous interaction(s) which set the variable being tested. This arrangement could similarly be used to, in effect, allow the system to conditionally execute or skip exceptions based on the context and history of the user's interactions.

For example, the exception:

[Topic/history] main part of the exception

has a gate (the terms between “[ ]”) that tests whether the variable “topic” has been set to “history” or not. This exception will then be used when a user's previous interactions have set “topic” to “history” but at other times will be skipped. The variable “topic” could, for example, be set to “history” as a consequence of the answer function of a matched exception (e.g. because it concerned a historical subject).

As will be discussed further below, the system of the present embodiment maintains a record of interactions with each individual user, so that meaningful dialogues can be held. A short buffer of items that have been referred to during the most recent interactions is maintained, together with attributes of those items. Exceptions can then be used to resolve ambiguous terms, such as pronouns, by reference to the recent history in the buffer.

In this way, the context of a previous interaction can be used to assist in the interpretation of a new message, so that abbreviation, pronouns or assumptions common in natural language may be correctly interpreted in the new message.

For example a first message

Who was King of England in 1904?

Could return the answer

Edward VII was king of England from 1901 to 1910

While a further question

Who was his mother?

Could correctly interpret “his” to refer to “Edward VII”, and return the answer

Queen Victoria was mother of Edward VII

In this example, the history buffer retained information that a person, who was male and a king, called Edward VII had been referred to. The use of the pronoun “his” then tracked back through the history to find the most recent male reference, allowing resolution of the ambiguity.

The set of exceptions, classes, etc., for a given service or application is created and merged automatically and sorted by the system at compile time from a defined set of source files. The source files preferably comprise one or more tables stored in a standard database format, where each table may be an exception table, a Knowledge Table or a class table, etc. A predefined project definition file defines (lists) which source files are used in each service or application.

The exceptions and knowledge are stored in the form of lists in separate files according to type and topic. For example, lists of countries could be stored in a file defining the class “country”, while lists of exceptions defining how to respond to greetings could be stored in another file.

Because the exception list for a given service can be automatically merged and sorted from one or more source files in this way, that allows different bodies of rules and knowledge to be arbitrarily combined into a new service or application without the need to manually order or arrange the exception list.

The exception sorting is not merely alphabetical, but instead arranges the data such that it will be searched in the order of how “specific” each exception is. In particular, the exception list is sorted automatically and then stored, so that the stored exceptions will, in essence, be searched from most specific to least specific.

In the present embodiment, a front to back search of the exception list is carried out, so the exceptions are sorted into and stored in an order such that a front to back search of the exception list will search the exceptions in the desired order. Other sorting and storing orders and searching (testing) orders can be used if desired. In essence, the sorted, stored exception list should match the intended searching sequence so that the exceptions will be searched in the desired order of more specific to less specific.

In general exceptions that have fewer possible matching inputs (i.e. that are more constrained) are considered more specific than exceptions that have more possible matching inputs (i.e. that are less constrained). However, it should be noted here that although it is preferred that the exceptions are in general sorted and tested in this order, within the overall sorting and testing sequence of the exceptions there can be cases where apparently less specific exceptions appear before more specific exceptions.

In the present embodiment, various permutations of exception construction, such as literal text, classes, “super” classes, etc., are defined to have an ordering from most to least specific, such that the process of adding new exceptions to the list can be automated, preserving the sorted order.

The present embodiment can be used to resolve anaphors, as will now be described.

An anaphor, as is known in the art, is an expression that refers to another. It can be difficult to resolve anaphors using automated language processing rules. An example of the linguistic problem of anaphors is the resolution of a pronoun such as ‘it’.

Suppose we read the sentence:

London had snow yesterday.

and then read one of the following sentences, all of which are sensible continuations. What is the it?

It also had fog. (It=London)

It fell to a depth of 1 metre. (It=the snow)

It will continue cold today. (It=the weather)

Handling pronouns is difficult, since the meaning of natural language cannot be determined in many cases from the meanings of words plus word ordering rules, without also applying wider knowledge.

The present embodiment addresses this problem by matching the input to exceptions that contain sequences of classes corresponding to possible sentence forms. From the identity of the classes matched, the context of the sentence is implicitly derived, and this can be stored for use in subsequent answer functions.

An example illustrates:

The following exception matches to London had snow yesterday

| Exception | Answer Function |
|---|---|
| {1/*loc} {5/\|*vmod} {2/*tohave} | [/save/loc/{1}][/save/wprep/{3}] |
| {3/*wprep} {4/*time} | OK! |

Where the following classes are defined (amongst possibly many others):

| *loc | *tohave | *wprep | *time | *wcon | *vmod |
|---|---|---|---|---|---|
| London | have | rain | today | Fog | Also |
| Paris | Has | snow | tomorrow | Cold | |
| | Had | | yesterday | | |
| | Will have | | | | |

| *wverb | *wmeasure | *height | *tobe |
|---|---|---|---|
| Fell | depth | 1 metre | Am |
| | | 2 metres | Is |
| | | 1 feet | Are |
| | | 2 feet | Was |
| | | 1 inch | Were |
| | | 2 inches | will be |
| | | | will continue |
| | | | will continue to be |

From left to right, the exception matches London to an entry in the *loc class and puts the root, “London”, into Wildcard (variable) 1. The *vmod class is optional because of the “|” and doesn't match anything. Next had matches to an entry in the *tohave class and puts the root “had” into Wildcard 2 and so on.

The fact that this exception is matched tells us that we are dealing with a sentence involving a location. That fact is stored by the answer function saving Wildcard 1 into a variable arbitrarily called “loc”. Similarly, the precipitation type is stored into a variable “wprep”.

The system can save a number of such things in any answer function. The system maintains a ring buffer of the variables saved from the last N executed answer functions (N is 2 in the present embodiment, but other values can be used if desired).

Suppose later in the dialogue, an exception containing a pronoun is matched. According to the particular exception matched, the meaning of the pronoun may be classified as, for example, a place or a precipitation type. The system can then look back in the ring buffer history to find the most recent save of a location name or a precipitation type, and infer the actual meaning of the pronoun.

For example the following exception matches

It also had fog (It=London)

and replies

In London. Really!

| | |
|---|---|
| [L\|loc]{1/it} {5/\|*vmod} {2/*tohave} {3/*wcon} | [/save/loc][/save/wcon] |
| {4/\|*time} | In {L/loc}. Really! |

In this exception the “L” gate (L for last) tests whether the variable “loc” has been set (during the last N answer functions). If it is not set, then the exception is skipped.

However, in this case “loc” is set to “London” and so the rest of the exception is tested. The “{1/it}” matches to “it” or the value of Wilcard 1 (in this case “London”). The rest of the exception then matches to classes as before.

The answer function then replies

“In {value of “loc”, i.e. “London”}. Really!”

The answer function also refreshes the save of “loc” and “wcon” for a further N exception matches.

This example shows how an anaphor (“it”) can be resolved according to context by using exception matching and a history buffer.

As discussed above, a key feature of the present invention is that information derived from or associated with one part of the input text is used together with information derived from or associated with another part of the input text (or a previous input text) to control the response of the system to the input text. This operation in the present embodiment will now be described, firstly by giving some overview examples, and then by describing the process as it is performed in the present embodiment in more detail.

In the present embodiment, this operation is performed by means of an “intersect” function that is triggered by the answer function of an exception, and operates to cross-reference attributes associated with different parts of the input text to see if there is any intersection between the attributes (i.e. to see if the different parts of the input text have any predefined associated attributes in common).

As an overview example of this operation, consider the situation where the user's input might refer to ‘mercury’, as in the question:

How heavy is mercury?

A matched exception will first divide this input into its parts “How”, “heavy”, “is” and “mercury”.

By use of classes, the system of the present embodiment can determine that the part “heavy” is in the “attribute+ of absolute” class, and the root of the class entry indicates that “heavy” is defined as being associated with the attributes “mass” and “density”.

Also the system can determine that the part of the input “Mercury” is in its “name” class, and the root of the class entry indicates that Mercury can be any of a god, a planet or an element.

Further, the system can use its attribute classes to determine the defined associated (in effect allowable) attributes of a god, an element or a planet. For example, the list of attributes associated with “planet” (in effect that can apply to “planet” in the system) may include diameter, mass, orbit, moons and density, amongst others.

The “Intersect” function will then cross-match the defined attributes associated with “heavy” with the attributes associated with gods, elements and planets (i.e. the possible meanings of “Mercury”) to find any intersection (matches) between the sets of associated attributes. If there is no intersection (matching attributes), then the system will answer that it doesn't understand the question (select a response indicating that).

In this example, the system can determine that there is an intersection (and therefore the question makes sense) for both the element mercury and the planet Mercury because the attributes of mass and density are associated with (applicable to) planets and the attribute of density is associated with (applicable to) elements, but neither is applicable to the god Mercury which can therefore be eliminated.

This helps to reduce ambiguity in the meaning of the input, but some ambiguity between “element” and “planet” remains, so the system preferably generates an output requesting clarification from the user, e.g.

Do you mean the element or the planet?

If the user then responds

element

the system can use this additional constraint, together with the previous information to remove the remaining ambiguity. The system can then look up the density of the element mercury in its knowledge database and respond accordingly. If the data were not available, the system could answer that it doesn't know the density of the element mercury.

If the user had responded

planet

the system would then have a choice of either mass or density, both of which satisfy the intersect (i.e. are defined attributes of “heavy” and of the planet Mercury). In a preferred embodiment these attributes are ranked in importance, and the first listed attribute takes precedence, e.g. in this case mass. The system can then look up the mass of the planet Mercury in its knowledge database and respond accordingly: The mass of Mercury is 3.3E+23 kg.

This example will now be worked through again in more detail, showing the classes used, and the operation of the Intersect function.

The question again is How heavy is Mercury?
The classes used in this example are—
Class: how query

how
how does
how is
how's
hows

Superclass: absolute

attribute+ of absolute
attribute− of absolute
attribute+/− of absolute

Class: attribute+ of absolute

big[diameter|height|volume|length|area|mass]
dense[density]
far[distance|orbit]
heavy[mass|density]
high[height]
. . .

Class: is-are

is
is there
are
are there

Superclass: named object

name anaphor
name
name alias

Class: name

abaco[island]
abeona[god]
abu dhabi[capital]
abudantia[god]
. . .
mercury[element|god|planet]
. . .

Class: planet

mercury[Mercury]
venus[Venus]
earth[Earth]
mars[Mars]
jupiter[Jupiter]
saturn[Saturn]
uranus[Uranus]
neptune[Neptune]

Class: element

actinium
aluminium
americium
antimony
argon
. . .
mercury
. . .

### Class: god

abeona
abudantia
adeona
apollo
. . .
mercury
. . .

Class: attribute of planet

albedo
density
diameter
length of day
length of year
mass
. . .

Class: attribute of element

atomic number
atomic weight
boiling point
density
discovery year
freezing point
group
. . .

Class: attribute of god

culture
gender
role

The input question How heavy is Mercury is first matched to an exception (a set of text strings), which identifies the entities in the input using the following text strings making up the exception as follows—

| | |
|---|---|
| how | member of ‘how query’ class |
| heavy | member of ‘attribute+ of absolute’ class, |
| | which is a member of the ‘absolute’ |
| | superclass |
| is | member of ‘is-are’ class |
| mercury | member of ‘name’ class, which is member of |
| | the named object superclass |

The system stores this match information. The available interpretations of “heavy” are extracted from the root of the “heavy” entry in the “attribute+ of absolute” class. In this example the root is denoted by being enclosed within [ ]. The root of “heavy” is mass|density, indicating that “heavy” makes sense for attributes of (is associated with the defined attributes) mass or density.

Mercury is a member of the name class, which identifies classes in which named objects appear. This provides a “reverse” look up for class membership. In this case the entry for Mercury has the root element|god|planet, indicating that “mercury” appears in each of these three classes.

The stored information is passed to the Intersect function, which compares the defined (allowable) attributes of “heavy”, i.e. mass or density, with the defined (allowable) attributes of element, god and planet, which are found in the corresponding classes “attributes of element”, “attributes of god”, and “attributes of planet”.

The list of attributes that can apply to planet include diameter, orbit, moons, and density as listed in the “attributes of planet” class.

The “Intersect” function cross-matches the determined defined attributes of heavy with the determined defined attributes of gods, elements and planets to find any intersection (common attributes) between the sets, as illustrated by the ticks in the following “intersect matrix”—

| | Mercury | | |
|---|---|---|---|
| heavy | Element | god | Planet |
| mass | | | ✓ |
| density | ✓ | | ✓ |

In this example, an intersection is found for both element and for planet, indicating that the question makes sense for either of these interpretations of mercury. In a preferred embodiment, a clarification step is accordingly carried out with the user, for example by outputting—

Do you mean the element or the planet?

in order to resolve this ambiguity.

The corresponding Intersect matrix for a similar question How heavy is Mars? can be illustrated as follows—

Mars

| heavy | God | Planet |
|---|---|---|
| mass | | ✓ |
| density | | ✓ |

In this case, as the “intersect” ticks appear in only a single column, then the interpretation of mars is unambiguous.

It would be possible in these examples to further clarify with the user—

Do you mean the mass or the density?

before providing the final response. However, in a preferred embodiment, the defined attributes of an adjective such as “heavy” are listed in preference order, and a question is answered immediately on the basis of this preference order (i.e. in respect of mass in the present case), to avoid sending clarifications.

The output of the Intersect function provides sufficient information to construct a database query, that can for example look up the mass of Mars in a table called planet, using the row indexed by Mars, and the column indexed by ‘mass’. The result is passed to an output manager module which constructs a suitably formatted reply.

(If there is no “intersection” (common attributes) found, then system preferably answers that it doesn't understand the question.)

In this way, the response to the user is controlled by using information associated with the parts “heavy” and “mars” in the input text.

An example exception (written in pseudocode) that will operate in the above manner is illustrated below. This exception will match, inter alia, to the input What's the diameter of Mercury the planet?

Exception (written in pseudocode)—

{class[what]}
{optional class[a]}
{memory 7.object = superclass[attribute]}
{for|in|of}
{memory 1.object = superclass[named object]}
{optional class[a]}
{memory 1.constraint = class[object type]};

This exception matches and divides up the input into parts as follows:

| | |
|---|---|
| What's | {class[what]} |
| the | {optional class[a]} |
| diameter | {memory 7.object = superclass[attribute]} |
| of | {for\|in\|of} |
| Mercury | {memory 1.object = superclass[named object]} |
| the | {optional class[a]} |
| planet | {memory 1.constraint = class[object type]}; |

### Explanation:

| | |
|---|---|
| What's | is a member of the what class. |
| the | is a member of the a class. |
| diameter | is a member of the attribute class which is in turn a member |
| | of the attribute superclass. diameter is assigned to the object |
| | portion of memory location 7 (this will be discussed |
| | further below). |
| of | is one of the literals for\|in\|of |
| Mercury | is a member of the named object class which is in turn a |
| | member of the named object superclass. Mercury is |
| | assigned to the object portion of memory location 1. |
| the | is a member of the a class. |
| planet | is a member of the object type class. planet is assigned to the |
| | constraint portion of memory location 1. |

The answer function for this exception contains a call to the intersect function and can be written in pseudocode as:

Intersect[what, memory 1, memory 7]
The query type (what, how, how many etc) is passed in the “Intersect” function because this affects the type of data that the Intersect function pulls out of the database. The memory locations (variable 1, variable 7) used are passed in so that the Intersect function knows which variables to intersect, i.e. which parts of the input text to determine information for and to use in controlling the response to the user). Only those portions of the stored data that are filled in by the exception are used in the intersect—in this case the object Mercury with the constraint of planet, and the attribute diameter.

As illustrated in the Example above, data derived from a user's input, and/or derived as a result of processing a user's input, is stored in memory (in particular variables (memory locations)) for future use. This storing of data is triggered by the exception (in the event of a match to the exception). It may also be triggered by the answer function associated with a matched exception.

In the present embodiment, the system maintains three “short term” memories or data stores, each of which store variables and other information determined from a given input of the user. There is one data store that stores data for the user's current input, one data store that stores data for the user's immediately preceding input, and one data store that stores data for the user's input prior to their immediately preceding input. These data stores can effectively be thought of as “short term memories” that retain information derived from the user's current and last two previous inputs.

The information stored in these “short term memories” comprises, in the present embodiment, one or more of information taken from the user's input, the processed results of the user's input, and information from the answer provided to that input.

These data stores (“short term memories”) are maintained on a first-in first-out basis, so that when new input is received, that input replaces the previous current input in memory, and the previous current input in memory moves to be the first previous input in memory, and so on.

Each of these short term memories for the user's inputs has a set of variables (such as the variables 1 and 7 in the Example discussed above) into which data can be stored. In the present embodiment, a number of different possible types of information can be stored for each variable (memory location), namely at least an “object” determined from the user's input (which may be a single item or a list of items) (such as “mercury”, for example), an “associate”, which will be an object or a list of objects related to the “object” (e.g. “moon” in this case), a “constraint” relating to the “object” (which again can be a single item or a list of items), and the identity of the class or classes used in the exception match for the particular input in question. These items may, e.g. be taken from the user's input or derived from processing of the input.

The above is one example of the type of constraint resolution that the Intersect function can perform. Another example involves anaphor resolution. For example, this may involve determination of the possible meanings of the word ‘it’ or ‘his’ in a query by reference to previous inputs, and then using the intersect function to apply all available constraint information to narrow down the meaning.

As an example, consider the following dialogue—

### How big is Mercury?

The diameter of Mercury is 4879.4 km.

What is its population?

I don't know the population of Mercury.

### France

The population of France is 64.1 million

In the query How big is Mercury, there will be no ambiguity over how Mercury should be construed, since the Intersect function can determine that only Mercury the planet is defined as having any attributes that are shared with attributes relating to big, while the god and the element do not. In fact in the present case two planet attributes match to attributes of big—diameter and mass, but these are ranked in order of preference, and the system takes the first one—diameter. The question can thus be answered directly without seeking clarification.

In the second question What is its population, the anaphor its is used. This is resolved to ‘the planet Mercury’ by reference to history stored from the previous question. Even if Mercury were also the name of a town, because Mercury has already been constrained to be a planet by the first question, the constraint is carried forward into the anaphor resolution. The Intersect function determines that there are no attributes of planet that correspond to population, and so the question cannot be answered. A suitable response is accordingly provided to the user.

Finally, in the third question France, previous information (‘what’ and ‘population’) is carried forward to complete the question, which is answered accordingly. (The input “France” is an example of a singleton input, and this illustrates how the present invention, in its preferred embodiment at least, may advantageously be used to process and respond to singleton inputs.)

The present embodiment also uses a “memory filter” to enhance the use of the intersect function. The “memory filter” is applied in advance of the intersect function and acts to apply any constraints that can be inferred from a user's previous input or inputs.

For example, if the first input in a new dialogue is—

How heavy is Mercury

then as described above, the system will determine an ambiguity about whether the user means the element or the planet and requests clarification.

However, if the context has already been set to ‘planet’ by a previous input then the behaviour is different. Consider the following series of inputs—

What's the diameter of Mars?

How heavy is Mercury?

In this case the intersect function run for the first input determines that Mars is constrained to be a planet. The constraint “planet” is stored and is carried forward into the processing of the second input by application of a memory filter using the stored constraint prior to running the intersect function for the second input. This “memory filter” stored constraint will initially limit the intersect function to considering planet as a possible column in the intersect table.

If the intersect succeeds with this memory constraint in place, then the system will deem, the user to be referring to the planet Mercury, and no further clarification will take place. In this case the intersect does succeed, since heavy does intersect with the planet Mercury, and the question can be answered. (Should application of the memory filter's stored constraint still result in ambiguity (i.e. a tick in more than one column in this implementation example) then clarification with the user will be sought.)

Consider now the dialogue inputs

### Who was the god Athene?

How heavy is Mercury?

In this case the intersect function run for the first input determines that object in question is constrained to be a god. Thus, the memory filter will initially limit the intersect function for the second input to only considering god as a possible column in the intersect table. The intersect will fail since “heavy” does not intersect with the god Mercury. In this situation, the intersect function is then re-run without the memory constraint. Behaviour is then as described above, where the intersect function identifies either element or planet as suitable candidates, resulting in a response in the form of a clarification step with the user.

A further enhancement of the memory filter takes into consideration the age of the constraint that is carried forward. Consider the dialogue inputs:

What size is Mercury?
How heavy is Mercury?

The intersect function for the first query constrains Mercury to be a planet, since size intersects only with the planet Mercury via the attributes diameter and mass. This constraint is carried forward into the second query by the memory filter, so that the second query is initially intersected only as a planet, and the intersect is successful. In this case the constraint carried forward was from the immediately previous input—this could be said to be a constraint of age 1.

In the following dialogue inputs, the same constraint would be carried forward

What size is Mercury?
What is the capital of France?
How heavy is Mercury?
but now the planet constraint is of age 2, because planet was used two inputs previously.

In a preferred embodiment of these examples, where a memory filter constraint of age 1 results in a successful intersect (first example), then the answer to the second input might be

The mass of Mercury is 3.3E+23 kg
but where a memory filter constraint of age 2 or more results in a successful intersect (second example), then the answer to the second input might be
The mass of the planet Mercury is 3.3E+23 kg
i.e. a clarification ‘the planet’ is included in the output to ensure clarity.

An example implementation of the memory filter can be illustrated as follows for the dialogue inputs—

What size is Mercury?
What is the capital of France?
How heavy is Mercury?

During processing of the final input, the memory is examined to determine the constraints that have been identified during the previous n inputs (thus n represents the permitted history length to be used by the memory filter). In the present case, n is two).

As before, Mercury yields matches in three classes, element, god and planet. Only these constraints are considered during the memory filter step. The oldest memory within the permitted history length is examined first, working back towards the most recent, so that more recent occurrences override less recent. In memory, a reference to a planet constraint is found 2 inputs ago. No other relevant references are found. The filter is then completed with a 2 in the planet box as shown below.

The intersect function is then completed considering only the columns that have non-zero values in the memory filter, in this case just planet.

| | Mercury | | |
|---|---|---|---|
| | Element | god | Planet |
| memory filter | | | 2 |
| heavy | | | |
| mass | | | 2 |
| density | | | 2 |

The question can then be answered directly, using the constraint planet:
The mass of the planet Mercury is 3.3E+23 kg

If an intersect with the memory filter is unsuccessful, then the intersect is repeated without the memory filter.

FIG. 7 is a flowchart showing the steps taken in executing the “intersect function” discussed above in more detail. Thus it shows the processing after an exception, for which the answer function indicates that an appropriate intersect function in the manner of the present embodiment should be carried out, has been matched.

Step 21 in FIG. 7 denotes the start of the intersect function process.

In step 22, a test is first made to see whether the variable (wild card) W₀ which is in the short term memory for the current input contains a single item or a list. If that variable is not a single item, then the process proceeds to step 32 where a response asking the user to specify further what he or she wants is returned to the user.

If at step 22 the test determines that the variable W₀ is a single item, then the process proceeds to step 23 where it is tested whether the constraint field for W₀ in short term memory for the user's current input is filled in or not (i.e. if a constraint is stored for the variable W₀ or not). An example of this would be if the variable W₀ contained the object Mercury, and there was a constraint for that variable of “planet”, as discussed above.

If the variable W₀ is constrained, then the process proceeds to step 33 where it is tested whether the identified constraint is valid or not. This is done in the present embodiment by looking in classes to see whether the identified constraint is defined as being appropriately associated with the object stored in the variable W₀.

If the constraint is found not to be valid, then the process proceeds to step 63 where an appropriate response, such as “I don't know of a planet called . . . ” is returned to the user.

If the constraint is found to be valid in step 33, then the process proceeds to step 34 where the constraint associated with the variable W₀ is applied, so as to act, as discussed above, as a controlling parameter in the intersect function.

The process then proceeds to step 35 where the relevant attributes of (options for) the object defined in the variable W₀ are retrieved (e.g. by looking up appropriate predefined classes), subject to the constraint that has been applied in step 34. This, in effect, defines the “x-axis” for the “intersect matrix” shown schematically above.

If at this stage there are no appropriate attributes (options) for the object defined in variable W₀, then the process proceeds to step 45 and an appropriate “fail” response is returned to the user.

If an appropriate set of attributes for the object in variable W₀ can be retrieved, then the process proceeds to step 37 where the appropriate attributes for the other part of the input text that is defined in the answer function to be subject to the “intersect” processing in the manner of the present embodiment are retrieved. In this case, this second part of the input that is shown as being the object stored variable 7₀ and so in step 37 the attributes associated with the object stored as variable 7₀ will be retrieved.

Again, if at this stage, the retrieved attributes for some reason are not appropriate or do not make sense, then the system can proceed to a “fail” response in step 47.

If the retrieved attributes for the second variable (effectively the y-axis of the intersect matrix described above) are appropriate, then the process proceeds to step 38 and sets the corresponding variable attributes (the y-axis options) for the intersect function.

The process then executes the intersect function as discussed above to cross-reference the attributes determined for the object W₀ (the x-axis of the intersect matrix) (i.e. the information derived from or associated with that part of the input text) and the attributes determined for the object 7₀ (the y-axis for the intersect matrix) (i.e. the information derived from or associated with that part of the input text) at step 2B.

The intersect function in step 2B then proceeds as described above to cross-reference the attributes determined for each of the variables being tested to see if there are, for example, attributes in common, and then triggers an appropriate response accordingly, such as to send a fail message (step 2C), to send a response seeking clarification (step 1A) if ambiguity remains in either of the variables (the parts of the input text being considered) following the intersect function, or to trigger a database look-up (step 1B) to derive a response to user if a definitive meaning has been established by the intersect function.

In this way, the information derived from or associated with each part of the input text (the parts stored as variables W₀ and 7₀) is used to control the system's response to the input text message (in these examples in relation to the response to be provided to the user in response to the user's input text message). The fail message may, e.g. be a predefined, fixed text, and the clarification response may, e.g., be a variable text string that is constructed using, at least in part, a word or words extracted from the input text. The database look-up if the intersect function resolves the meaning of the input unambiguously is an example of a response where a function may be executed to construct or generate the response to the user based on the processing of the information derived from or associated with the relevant parts of the input text.

FIG. 7 also shows what happens if the first part of the input, the variable W₀, to be tested is not found to have any constraints associated with it in step 23. In this case, the process proceeds to step 24 and first determines whether the variable W₀ is an anaphor (e.g. if the object stored for variable W₀ is “its” or similar).

If the variable W₀ is not found to be an anaphor, the process proceeds to step 25, where, as discussed above in relation to step 35, the system then determines the relevant attributes for the variable W₀, for example, by looking those attributes up in the appropriate classes. This determines, as discussed above, the x-axis options for the intersect “matrix”.

Again, if there is a “fail” at this stage, then an appropriate response can be provided in step 15.

If appropriate attributes can be retrieved, then the process proceeds to step 26 where the “memory filter” representing the user's previous interaction history is applied in the manner discussed above to the determined attributes.

The process then proceeds to step 27 where, as discussed above, the relevant attributes for the other part of the user's input that is to be subject to the intersect function (in this case the object defined as variable 7₀, as discussed above) are retrieved, again, for example, by looking up the relevant attributes in appropriate classes. This is then used to set the attributes for the “y-axis” of the intersect function “matrix” in step 28.

The intersect function is then applied using the determined attributes in step 29, and, as discussed above, will, for example, trigger a response that seeks clarification from the user if ambiguity remains in the interpretation of one part (one axis) of the intersect function (step 19a), or will, for example, trigger a database look up to return a response to the user if a definitive meaning of the user's input can be established by the intersect function (step 19b).

If at this stage the intersect function does not allow the system to derive an appropriate response with the attributes that have been set, then the process proceeds to step 2A, where the relevant attributes for the variable W₀ (for the “x-axis” in the intersect “matrix”) are derived again, but this time without using any constraints derived from the user's previous input (without applying the memory filter discussed above). The intersect function is then repeated in step 2B in the manner discussed above (but in this case with the memory filter omitted).

In this way, if the process cannot derive a satisfactory result with the memory filter applied, the memory filter is then removed and the intersect function repeated with the memory filter omitted.

If at step 24 it is determined that the object stored in W₀ is an anaphor then the process proceeds to step 34 where possible anaphor candidates are identified by looking in the short term memory stores for the user's previous inputs to identify anaphor candidates. If no anaphor candidates are found, then step 54 triggers an appropriate “fail” response at step 64. This may, e.g. be in the form of a fixed, predefined text string to be returned to the user, or a text string that incorporates parts of the user's input.

On the other hand, if at step 54 it is found that there are suitable anaphor candidates, then the process proceeds to step 56 where the relevant attributes for the other part of the user's input that is to be subject to the intersect function (in this case stored in the variable 7₀, as discussed above) are retrieved in the manner discussed above, and used to set the attributes for that part of the intersect function (to set the options for the y-axis of the intersect “matrix”) at step 57.

One of the anaphor candidates determined in step 44 is then selected and used to determine the appropriate attributes for that part of the user's input that is to be subject to the intersect function at step 58.

The intersect function is then executed as discussed above at step 59, and depending upon the results of that processing, a response seeking clarification from the user is sent (step 69a), or a database look up is triggered (step 69b) or, if the function fails, a determination is made at step 5B to see if there are any more anaphor candidates, and if there are, steps 58 and 59 are repeated using another possible anaphor candidate, and so on, until all the anaphor candidates have been tried. If at that stage an appropriate interpretation and response cannot be derived, then a “fail” response is sent at step 5c.

In the case of the above discussed Examples, the input “how heavy is the planet mercury” would proceed through this process via the route of steps 33 and 38, and “how heavy is mercury” would proceed via steps 24 and 28.

Although the above embodiments have been described primarily with reference to a process in which only two parts of the input text are subject to the processing in the manner of the present invention (subjected to an intersect function as discussed above), in a preferred embodiment it is possible to trigger multiple intersect functions in a single answer function. Indeed the applicants have recognised that some inputs may need to be processed in this manner in order to be able to fully interpret them for the purposes of providing a response.

For example, if there is an exception that matches the input query “when was his father's wife born?”, it may not be possible to sort out an appropriate answer to this by applying a single intersect function, because the solution to the query may involve a number of indirect steps.

In this case, the answer function for the exception that matches this input query may be configured to specify a series of intersect functions each of which will solve one piece of query and then assign that solution to a variable to be used by another intersect function in the answer function to solve the next piece of the query and so on (i.e. to specify that different parts of this input should be processed in the manner of the present invention, and then the results of that processing used together with information derived from or associated with another part of input text to provide a further result, and so on).

For example, if applying this to the above query, anaphor resolution may first be used to determine, for example, that “his” refers to “Charles Darwin”. A first intersect function may then be used to intersect “Charles Darwin” (derived from “his”) and “father”, to interpret “his father” in the input. This may provide the result “Robert Darwin”, which can then be assigned to (stored as) a variable. A second intersect function may then be defined that intersects this result, “Robert Darwin”, with “wife”, to interpret the meaning of “wife” in the input, so that “wife” can be interpreted as the result “Susannah Wedgwood” which again can be assigned to a variable. Finally, that variable object “Susannah Wedgwood” can be intersected with “born” from the user's input to provide an answer to “when born”, by, for example, cross-referencing “Susannah Wedgwood” and “born” to find the desired result, or using this information to look-up the answer in a database. The answer can then be output to the user.

The answer function may appropriately configured to trigger this sequence of intersect functions if the relevant exception is matched. Similarly, the exception may be configured to store the various parts of the input as variables (if the exception is matched), as discussed above. If at any stage one of the intersect functions fails, then an appropriate response can be returned, e.g. “I don't know when Susannah Wedgwood was born”.

Although the above embodiments have been described with particular reference to seeking clarification from a user if there ambiguity remains in the interpretation of one part of the input following the intersect function (e.g. in the “x axis” of the intersect “matrix” in the examples given above), it would, of course, be possible to also or instead seek clarification if there is ambiguity in interpretation of the other part (or parts) being tested (e.g. the “y-axis” of the intersect “matrix”), if desired.

Similarly, although the present embodiment has been described above with reference primarily to using the “intersect” function with two (or more) parts of the current input text, it would equally be possible to “intersect” a part or parts of the current input text with a part or parts of a previous input text (or a part or parts of more than the previous input text), if desired.

Also, although in the above examples the response of the system that is controlled in accordance with the operation in the manner of the present invention has primarily been described as being the form of the response text message that is to be sent to the user, other responses of the system to the input text message could also or instead be controlled in accordance with the operation in the manner of the present invention. For example, the operation in the manner of the present invention could also or instead be used to control the setting of the internal state of the system (e.g. the storing of data by the system) in response to the input text message, if desired.

It can be seen from the above that the present invention, in its preferred embodiments at least, provides a system that can respond to natural language text queries with improved decision making, and, inter alia, better handling and resolution of: anaphors and omitted text in inputs, singleton inputs, and context switching in a sequence of inputs from a user.

Incomplete information can be completed by reference to information stored during the processing of previous input, while ambiguous input can be resolved by application of constraints by an “Intersect” function, where the constraints can be derived from the processing of either the current input, or a combination of the current input and information stored or derived during the processing of previous input.

This is achieved in the preferred embodiments of the invention at least by interpreting the input text string by dividing it up into discrete parts by a matching process, assigning one or more of the parts to variables and attempting to resolve any ambiguity in the meaning of the parts by applying to one part a constraint in meaning derived from another part.

Furthermore, in a preferred embodiment if all ambiguity cannot be removed by reference to the present input alone, then further constraint is applied to the meaning of the input by reference to variables stored during the processing of a previous input string or strings.

Preferably the determined meaning of the parts of the input text is used to form an output string.

The present invention, in its preferred embodiments at least, provides a highly flexible and powerful means for quick and effective text interaction with automated systems. The system can analyse the content of a received text string and provide an appropriate action and/or reply.

Input messages do not need to be in a fixed format as the present invention can handle natural language input. Therefore, as few demands are placed upon the user, service usage can be maximised.

The present invention has application in any situation where text interaction may be advantageous, for example personal or commercial information systems where users desire to obtain concise information easily or interact with an automated system, or where customer services interactions take place between users and organisations.

The invention has particular utility when accessed via the text messaging capability of a telephone network, such as a cellular mobile telephone network, wherein facilities for entering and receiving text using a personal device are already well established.

In this case, the present invention can be utilised in a variety of applications that involve text input derived from a short text message to solicit an automated action or a text output. The invention can allow network operators to reduce costs, improve quality of service, or build new revenue streams using a text messaging service such as the Short Message Service (SMS) of the GSM mobile telephony standard. For example, by offering an interactive text service, operators can provide their customers with an enhanced level of service, 24 hours a day, 7 days a week, at low cost and with maximum flexibility.

It can enable service discovery and easy access to multimedia content, since a number to dial or a WAP or web link can be returned to the user as means of referencing the desired information or service.

The invention can also, for example, be used to process a text query to a data resource on a public or personal computer system, such as in a Library or on a home PC, which could be conveniently be input via a keyboard or fixed terminal.

Indeed, the invention may be applied in any situation where textual input may be supplied by a user to solicit an automated action or a text reply. For example the text input may be provided from the output of an automatic speech recogniser.

1. A method of processing an input text message in an automated text message processing system, the method comprising:
the system:
using a matching process to divide an input text message into one or more parts; and
using information derived from or associated with a part or parts of the input text determined by the matching process, together with information derived from or associated with another part or parts of the input text determined by the matching process and/or with information derived from or associated with a part or parts of a previous input text, to control the response of system to the input text message.

2. The method of claim 1, further comprising the system:
receiving a text message and processing that text message to one or more derived forms; and then providing one or more of the derived forms of the received text message as an input text message or messages to the matching process.

3. The method of any one of the preceding claims, wherein the information that is derived from or associated with a part or parts of an input text message that is used to control the response of the system to the input text message comprises information that is predefined as being associated with a text string or strings that the determined part or parts of the input text is determined as matching to by the matching process.

4. The method of any one of the preceding claims, wherein the step of controlling the response of the system to the input text message using information derived from or associated with a part or parts of the input text determined by the matching process, together with information derived from or associated with another part or parts of the input text determined by the matching process and/or with information derived from or associated with a part or parts of a previous input text comprises:
controlling the response to be provided to the user, and/or the state of the system, in response to the input text message, using the information derived from or associated with a part or parts of the input text determined by the matching process, together with the information derived from or associated with another part or parts of the input text determined by the matching process and/or with the information derived from or associated with a part or parts of a previous input text.

5. The method of any one of the preceding claims, comprising controlling the response of the system to the input text message by using the information derived from or associated with the parts of the input text, and/or a previous input, as, or to derive, an input or inputs to a function or operation that will then construct or derive the response of the system.

6. The method of any one of the preceding claims, comprising using the information that is derived from or associated with the parts of the input text to apply a constraint or constraints when determining the response of the system.

7. The method of any one of the preceding claims, wherein the step of using information derived from or associated with the part or parts of the input text, or a previous text input, comprises cross-referencing information derived from or associated with one part of the input text, with information derived from or associated with another part of the input text, and/or with information derived from or associated with a part of a previous text input.

8. The method of any one of the preceding claims, wherein the matching process uses a plurality of stored exceptions to be matched against input text messages, each exception defining at least one text string that a text string derived from an input text message must match for the exception to be matched and having associated with it an answer function that is to be executed in the event of the exception being matched; and
one or more of the stored exceptions have associated answer functions that will cause the system as a result of executing the answer function to use information derived from or associated with a part or parts of the input text determined by the matching process, together with information derived from or associated with another part or parts of the input text determined by the matching process and/or with information derived from or associated with a part or parts of a previous input text, to control the response of the system to the input text message.

9. The method of any one of the preceding claims, comprising the system deriving information from processing two or more parts of the input text, and then using that information together with a further part of the input text to derive further information for controlling the system's response.

10. The method of any one of the preceding claims, comprising using information derived from a user's previous input or inputs to constrain the processing of the user's current input.

11. The method of any one of the preceding claims, comprising the system:
storing information derived from a user's input;
replacing or supplementing the stored information with information derived from processing of the user's input; and
using the stored information when processing another input text message from the user.

12. A method of providing an application or service that may be accessed and used via the sending of text messages in a mobile telephony network, the method comprising:
the mobile telephony network identifying a text message sent by a user that is intended for the application or service and directing the text message accordingly to a text message processing system for the application or service; and
the text message processing system for the application or service:
receiving the text message;
using a matching process to divide the input text message into one or more parts; and
using information derived from or associated with a part or parts of the input text determined by the matching process, together with information derived from or associated with another part or parts of the input text determined by the matching process and/or with information derived from or associated with a part or parts of a previous input text, to control the response of system to the input text message.

13. An apparatus for interpreting and responding to a text input message received by the apparatus, the apparatus comprising:
means for processing an input text message using a matching process to divide the input text message into one or more parts; and
means for using information derived from or associated with a part or parts of the input text determined by the matching process, together with information derived from or associated with another part or parts of the input text determined by the matching process and/or with information derived from or associated with a part or parts of a previous input text, to control the response of system to the input text message.

14. The apparatus of claim 13, further comprising:
means for receiving a text message and processing that text message to one or more derived forms; and
means for providing one or more of the derived forms of the received text message as an input text message or messages to the matching process.

15. The apparatus of claim 13 or 14, wherein the information that is derived from or associated with a part or parts of an input text message that is used to control the response of the system to the input text message comprises information that is predefined as being associated with a text string or strings that the determined part or parts of the input text is determined as matching to by the matching process.

16. The apparatus of any one of claims 13 to 15, wherein the means for controlling the response of the system to the input text message using information derived from or associated with a part or parts of the input text determined by the matching process, together with information derived from or associated with another part or parts of the input text determined by the matching process and/or with information derived from or associated with a part or parts of a previous input text comprises:
means for controlling the response to be provided to the user, and/or the state of the system, in response to the input text message, using the information derived from or associated with a part or parts of the input text determined by the matching process, together with the information derived from or associated with another part or parts of the input text determined by the matching process and/or with the information derived from or associated with a part or parts of a previous input text.

17. The apparatus of any one of claims 13 to 16, comprising means for controlling the response of the system to the input text message by using the information derived from or associated with the parts of the input text, and/or a previous input, as, or to derive, an input or inputs to a function or operation that will then construct or derive the response of the system.

18. The apparatus of any one of claims 13 to 17, comprising means for using the information that is derived from or associated with the parts of the input text to apply a constraint or constraints when determining the response of the system.

19. The apparatus of any one of claims 13 to 18, wherein the means for using information derived from or associated with the part or parts of the input text, or a previous text input, comprises means for cross-referencing information derived from or associated with one part of the input text, with information derived from or associated with another part of the input text, and/or with information derived from or associated with a part of a previous text input.

20. The apparatus of any one of claims 13 to 19, wherein the matching process uses a plurality of stored exceptions to be matched against input text messages, each exception defining at least one text string that a text string derived from an input text message must match for the exception to be matched and having associated with it an answer function that is to be executed in the event of the exception being matched; and
one or more of the stored exceptions have associated answer functions that will cause the system as a result of executing the answer function to use information derived from or associated with a part or parts of the input text determined by the matching process, together with information derived from or associated with another part or parts of the input text determined by the matching process and/or with information derived from or associated with a part or parts of a previous input text, to control the response of the system to the input text message.

21. The apparatus of any one of claims 13 to 20, comprising means for deriving information from processing two or more parts of the input text, and then using that information together with a further part of the input text to derive further information for controlling the system's response.

22. The apparatus of any one of claims 13 to 21, comprising means for using information derived from a user's previous input or inputs to constrain the processing of the user's current input.

23. The apparatus of any one of claims 13 to 22, comprising:
means for storing information derived from a user's input;
means for replacing or supplementing the stored information with information derived from processing of the user's input; and
means for using the stored information when processing another input text message from the user.

24. A system for providing an application or service that may be accessed and used via the sending of text messages in a mobile telephony network, the system comprising:
a text message processing system for the application or service comprising:
means for receiving an input text message;
means for processing an input text message using a matching process to divide the input text message into one or more parts; and
means for using information derived from or associated with a part or parts of the input text determined by the matching process, together with information derived from or associated with another part or parts of the input text determined by the matching process and/or with information derived from or associated with a part or parts of a previous input text, to control the response of system to the input text message; and
the system further comprising:
means for identifying a text message sent by a user that is intended for the application or service and for directing the text message accordingly to the text message processing system for the application or service.

25. A mobile telephony system that includes the apparatus of any one of claims 13 to 24, or that is operated in accordance with the method of any one of claims 1 to 12.

26. A computer program element comprising computer software code portions for performing the method of any one of claims 1 to 12 when the program element is run on data processing means.

27. A method of processing an input text message in an automated text message processing system substantially as herein described with reference to any one of the accompanying drawings.

28. An apparatus for interpreting and responding to a text message substantially as herein described with reference to any one of the accompanying drawings.
